(19) United States
(12) Patent Application Publication
(10) Pub. No.: US 2014/0039089 A1
(43) Pub. Date: Feb. 6, 2014

(54) Compositions Containing Phosphonate Catalysts And Methods For The Preparation And Use Of The Compositions

(71) Applicants: Simon Cook, Midland, MI (US); Geraldine Durand, Cardiff (GB); Thomas Easton, Barry (GB); Victoria James, Cardiff (GB); Sarah O"Hare, Barry (GB); Avril Surgenor, Waterloo (BE); Richard Taylor, Penarth (GB)

(72) Inventors: Simon Cook, Midland, MI (US); Geraldine Durand, Cardiff (GB); Thomas Easton, Barry (GB); Victoria James, Cardiff (GB); Sarah O"Hare, Barry (GB); Avril Surgenor, Waterloo (BE); Richard Taylor, Penarth (GB)

(73) Assignee: Dow Corning Corporation, Midland, MI (US)

(21) Appl. No.: 14/007,747

(22) PCT Filed: Mar. 12, 2012
(86) PCT No.: PCT/US12/28689

§ 371 Date: Sep. 26, 2013

Related U.S. Application Data
(60) Provisional application No. 61/469,839, filed on Mar. 31, 2011.

(51) Int. Cl. C08L 83/04

(52) U.S. Cl. CPC C08L 83/04
USPC 523/122; 525/474; 524/588

(57) ABSTRACT

A composition is capable of curing via condensation reaction. The composition uses a phosphonate condensation reaction catalyst. The phosphonate is used to replace conventional tin catalysts. The composition can react to form a gum, gel, or rubber.

### CROSS-REFERENCE TO RELATED APPLICATIONS AND STATEMENT REGARDING FEDERALLY SPONSORED RESEARCH

None.

### TECHNICAL FIELD

Condensation reaction curable compositions contain new phosphonate catalysts. The compositions can cure without the presence of conventional catalysts, such as organotin catalysts.

### BACKGROUND

Tin compounds are useful as catalysts for the condensation cure of many polyorganosiloxane compositions, including adhesives, sealants, low permeability products such as those useful in insulating glass applications, coatings, and silicone elastomer latices.

Organotin compounds for condensation reaction catalysis are those where the valence of the tin is either +4 or +2, i.e., Tin (IV) compounds or Tin (II) compounds. Examples of tin (IV) compounds include stannic salts of carboxylic acids such as dibutyl tin dilaurate (DBTDL), dimethyl tin dilaurate, di-(n-butyl)tin bis-ketonate, dibutyl tin diacetate, dibutyl tin maleate, dibutyl tin diacetylacetonate, dibutyl tin dimethoxide, carbomethoxyphenyl tin tris-uberate, dibutyl tin dioctoate, dibutyl tin diformate, isobutyl tin triceroate, dimethyl tin dibutyrate, dimethyl tin di-neodeconoate (DMDTN), dibutyl tin di-neodeconoate, triethyl tin tartrate, dibutyl tin dibenzoate, butyltintri-2-ethylhexoate, dioctyl tin diacetate, tin octylate, dibutyl tin dioctoate, tin oleate, tin butyrate, tin naphthenate, dimethyl tin dichloride, a combination thereof, and/or a partial hydrolysis product thereof. Tin (IV) compounds are known in the art and are commercially available, such as Metatin® 740 and Fascat® 4202 from Acima Specialty Chemicals of Switzerland, Europe, which is a business unit of The Dow Chemical Company. Examples of tin (II) compounds include tin (II) salts of organic carboxylic acids such as tin (II) diacetate, tin (II) dioctanoate, tin (II) diethylhexanoate, tin (II) dilaurate, stannous salts of carboxylic acids such as stannous octoate, stannous oleate, stannous acetate, stannous laurate, stannous stearate, stannous naphthanate, stannous hexoate, stannous succinate, stannous caprylate, and a combination thereof.

REACH (Registration, Evaluation, Authorization and Restriction of Chemical) is European Union legislation aimed to help protect human health and the environment and to improve capabilities and competitiveness through the chemical industry. Due to this legislation, tin based catalysts, which are used in many condensation reaction curable polyorganosiloxane products such as sealants and coatings, are to be phased out. Therefore, there is an industry need to replace conventional tin catalysts in condensation reaction curable compositions.

### BRIEF SUMMARY OF THE INVENTION

A composition capable of reacting via condensation reaction comprises:

(A) a phosphonate condensation reaction catalyst, and
(B) a base polymer.

The Ingredient (A) is capable of catalyzing condensation reaction of the composition.

### DETAILED DESCRIPTION OF THE INVENTION

### Definitions and Usage of Terms

All amounts, ratios, and percentages are by weight unless otherwise indicated. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group a hydrogen atom, an alkyl group, an aryl group, an aralkyl group, or an alkaryl group includes the member alkyl individually; the subgroup alkyl and aryl; and any other individual member and subgroup subsumed therein.

“Free of” means that the composition contains a non-detectable amount of the ingredient, or the composition contains an amount of the ingredient insufficient to change the tack free time measured by the method in Reference Example 2 as compared to the same composition with the ingredient omitted. For example, the composition described herein may be free of tin catalysts. “Free of tin catalysts” means that the composition contains a non-detectable amount of a tin catalyst capable of catalyzing a condensation reaction with the hydrolyzable groups on other ingredients in the composition, or the composition contains an amount of a tin catalyst insufficient to change the tack free time measured by the method in Reference Example 2, as compared to the same composition with the tin catalyst omitted. The composition may be free of titanium catalysts. “Free of titanium catalysts” means that the composition contains a non-detectable amount of a titanium catalyst capable of catalyzing a condensation reaction with the hydrolyzable groups on other ingredients in the composition, or the composition contains an amount of a titanium catalyst insufficient to change the tack free time measured by the method in Reference Example 2, as compared to the same composition with the titanium catalyst omitted. Alternatively, the composition described herein may be free of metal condensation reaction catalysts. “Free of metal condensation reaction catalysts” means that the composition contains a non-detectable amount of a compound of a Group 3a, 4a, 5a, or 4b metal of the periodic table, which is capable of catalyzing a condensation reaction, such as compounds of Al, Bi, Sn, Ti, and/or Zr; or an amount of such a metal condensation reaction catalyst insufficient to change the tack free time measured by the method in Reference Example 2 as compared to the same composition with the metal condensation reaction catalyst omitted.

“Non-functional” means that the ingredient, e.g., a polyorganosiloxane, does not participate in a condensation reaction.

These abbreviations are defined as follows. The abbreviation “cP” refers to centiPoise. “DP” refers to the degree of polymerization of a polymer. “FTIR” refers to Fourier transform infrared spectrophotometry. “GPC” refers to gel permeation chromatography. “Mn” refers to number average molecular weight of a polymer. Mn may be measured using GPC. “Mw” refers to weight average molecular weight of a polymer. “NMR” refers to nuclear magnetic resonance.

### Composition

A composition that is capable of reacting by condensation reaction (composition) comprises:

(A) a phosphonate condensation reaction catalyst, and
(B) a base polymer having an average, per molecule, of one or more hydrolyzable substituents. The composition may optionally further comprise one or more additional ingredients. The one or more additional ingredients may be distinct from ingredients (A) and (B). Suitable additional ingredients are exemplified by (C) a crosslinker; (D) a drying agent; (E) an extender, a plasticizer, or a combination thereof; (F) a filler; (G) a filler treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a solvent; (T) a tackifying agent; and a combination thereof.

### Ingredient (A) Phosphonate Condensation Reaction Catalyst

Ingredient (A) comprises a phosphonate. The phosphonate may comprise a monomeric phosphonate, a polymeric phosphonate, or a combination thereof. The phosphonate may comprise an organic phosphonate, a silyl phosphonate, or a combination thereof.

The phosphonate may have average general formula (I):

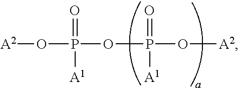

where
each A¹ is independently a monovalent hydrocarbon group;
each A² is independently selected from a hydrogen atom, a monovalent organic group, a silyl group of formula —SiA³₃, where each A³ is independently a monovalent hydrocarbon group, or a siloxane group; and
subscript a has a value of 0 or greater.

Alternatively, in formula (i) above, each group A¹ is independently a monovalent hydrocarbon group; and each A² is independently a hydrogen atom, a monovalent hydrocarbon group, or a silyl group. Examples of monovalent hydrocarbon groups for A¹, A², and A³ include, but are not limited to, alkyl such as methyl, ethyl, propyl, pentyl, hexyl, heptyl, ethylhexyl, octyl, decyl, dodecyl, undecyl, and octadecyl; alkenyl such as vinyl, allyl, propenyl, and hexenyl; cycloalkyl such as cyclopentyl and cyclohexyl; aryl such as phenyl, tolyl, and xylyl; alkaryl such as benzyl; and aralkyl such as 2-phenylethyl. Subscript a may have a value ranging from 0 to 50, alternatively 0 to 20. Alternatively, when ingredient (A) is a monomeric phosphonate, subscript a has a value of 0. Alternatively, each A¹ is independently an alkyl group of 1 to 8 carbon atoms or an alkenyl group of 1 to 8 carbon atoms; and each A² is independently a hydrogen atom, an alkyl group of 1 to 4 carbon atoms, or a silyl group in which each A³ is independently an alkyl group of 1 to 4 carbon atoms. Examples of suitable alkyl groups for A¹ and A² and A³ are methyl, ethyl, propyl, butyl, hexyl, ethylhexyl, and octyl. Alternatively, each A¹ and each A³ may be independently selected from methyl, vinyl, and octyl. Alternatively, each A² may be independently selected from a hydrogen atom or a silyl group. Alternatively, each A² may be independently selected from a hydrogen atom or an organic group. Alternatively, each A² may be independently selected from a hydrogen atom or a monovalent hydrocarbon group, such as alkyl or alkenyl; alternatively alkyl. One skilled in the art would recognize that average formula (i) can represent an equilibrium mixture of species, where at least some of the molecules of formula (i) present contain a silyl group and some of the molecules of formula (i) do not contain a silyl group.

Ingredient (A) may comprise diethenyl-diphosphonic acid, vinylphosphonic acid, bis(trimethylsilyl) vinylphosphonate, trimethylsilyl vinylphosphonic acid, bis(dimethylvinylsilyl) vinylphosphonate, dimethylvinylsilyl vinylphosphonic acid, dimethyl methylphosphonate, bis(trimethylsilyl) octylphosphonate, trimethylsilyl octylphosphonate, and octylphosphonic acid, or a combination thereof. Alternatively, ingredient (A) may comprise a mixture of bis(trimethylsilyl) octylphosphonate, trimethylsilyl octylphosphonate, and octylphosphonic acid. Phosphonates are commercially available. For example, DOW CORNING® 4-6085 is a mixture comprising monomeric silyl phosphonate and monomeric organic phosphonate species; DOW CORNING® 4-6025 is a mixture comprising monomeric and polymeric phosphonate species; and DOW CORNING® 4-6035 is also a commercially available phosphonate. These phosphonates are all available from Dow Corning Corporation of Midland, Mich., U.S.A. Dimethyl methylphosphonate is also commercially available.

The composition may contain one single phosphonate condensation reaction catalyst. Alternatively, the composition may comprise two or more phosphonate condensation reaction catalysts described above as ingredient (A), wherein the two or more phosphonate condensation reaction catalysts differ in at least one property such as structure, viscosity, molecular weight, and definitions for A¹, A², and A³. The composition may be free of tin catalysts. The composition may be free of titanium catalysts. Alternatively, the composition may be free of metal condensation reaction catalysts. Alternatively, the composition may be free of any phosphonate that would catalyze the condensation reaction of the hydrolyzable groups on ingredient (B) other than the phosphonate condensation reaction catalyst defined herein as ingredient (A). Alternatively, the composition may be free of any ingredient that would catalyze the condensation reaction of the hydrolyzable groups on ingredient (B) other than the phosphonate condensation reaction catalyst defined herein as ingredient (A).

### Ingredient (B) Base Polymer

Ingredient (B) is a base polymer. Ingredient (B) comprises a polymer backbone having an average, per molecule, of one or more hydrolyzable substituents covalently bonded thereto. Alternatively, the one or more hydrolyzable substituents are silyl hydrolyzable substituents. The polymer backbone may be selected from a polyorganosiloxane such as a polydiorganosiloxane, an organic polymer backbone, or a silicone-organic copolymer backbone. Alternatively, the polymer backbone of ingredient (B) may be a polyorganosiloxane backbone, or an organic backbone. Alternatively, the polymer backbone of ingredient (B) may be a polyorganosiloxane backbone. The hydrolyzable substituents are exemplified by halogen atoms; amido groups such as acetamido groups, benzamido groups, or methylacetamido groups; acyloxy groups such as acetoxy groups; hydrocarbonoxy groups such as alkoxy groups or alkenyloxy groups; amino groups; aminoxy groups; hydroxyl groups; mercapto groups; oximo groups; ketoximo groups; alkoxysilylhydrocarbylene groups; or a combination thereof. Alternatively, ingredient (B) may have an average of two or more hydrolyzable substituents per molecule. The hydrolyzable substituent in ingredient (B) may be located at terminal, pendant, or both terminal and pendant positions on the polymer backbone. Alternatively, the hydrolyzable substituent in ingredient (B) may be located at one or more terminal positions on the polymer backbone. Ingredient (B) may comprise a linear, branched, cyclic, or resinous structure. Alternatively, ingredient (B) may comprise a linear, branched or cyclic structure. Alternatively, ingredient (B) may comprise a linear or branched structure. Alternatively, ingredient (B) may comprise a linear structure. Alternatively, ingredient (B) may comprise a linear structure and a resinous structure. Ingredient (B) may comprise a homopolymer or a copolymer or a combination thereof.

Ingredient (B) may have the hydrolyzable substituents contained in groups of the formula (ii):

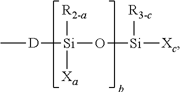

where each D independently represents an oxygen atom, a divalent organic group, a silicone organic group, or a combination of a divalent hydrocarbon group and a divalent siloxane group; each X independently represents a hydrolyzable substituent; each R independently represents a monovalent hydrocarbon group; subscript c represents 0, 1, 2, or 3; subscript a represents 0, 1, or 2; and subscript b has a value of 0 or greater, with the proviso that the sum of (a+c) is at least 1, such that, on average, at least one X is present in the formula. Alternatively, subscript b may have a value ranging from 0 to 18.

Alternatively, each D may be independently selected from an oxygen atom and a divalent hydrocarbon group. Alternatively, each D may be an oxygen atom. Alternatively, each D may be a divalent hydrocarbon group exemplified by an alkylene group such as ethylene, propylene, butylene, or hexylene; an arylene group such as phenylene, or an alkylarylene group such as:

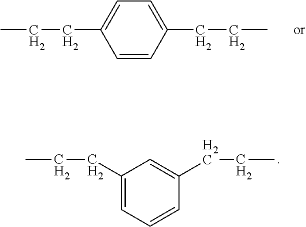

Alternatively, an instance of D may be an oxygen atom while a different instance of D is a divalent hydrocarbon group.

Alternatively, each X may be selected from the group consisting of an alkoxy group; an alkenyloxy group; an amido group, such as an acetamido, a methylacetamido group, or benzamido group; an acyloxy group such as acetoxy; an amino group; an aminoxy group; a hydroxyl group; a mercapto group; an oximo group; a ketoximo group; and a halogen atom. Alternatively, each X may be selected from the group consisting of an alkoxy group, an amido group, an acyloxy group, an amino group, a hydroxyl group, and an oximo group.

Alternatively, each R in the formula above may be independently selected from alkyl groups of 1 to 20 carbon atoms, aryl groups of 6 to 20 carbon atoms, and aralkyl groups of 7 to 20 carbon atoms.

Alternatively, subscript b may be 0.

Ingredient (B) may comprise the groups described by formula (II) above in an amount of the base polymer ranging from 0.2 mol % to 10 mol %, alternatively 0.5 mol % to 5 mol %, alternatively 0.5 mol % to 2.0 mol %, alternatively 0.5 mol % to 1.5 mol %, and alternatively 0.6 mol % to 1.2 mol %.

Ingredient (B) may have a polyorganosiloxane backbone with a linear structure, i.e., a polydiorganosiloxane backbone. When ingredient (B) has a polydiorganosiloxane backbone, ingredient (B) may comprise an alkoxy-endblocked polydiorganosiloxane, an alkoxysilylhydrocarbylene-endblocked polydiorganosiloxane, a hydroxyl-endblocked polydiorganosiloxane, or a combination thereof.

Ingredient (B) may comprise a polydiorganosiloxane of formula (I):

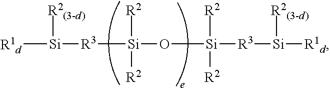

where each R¹ is independently a hydrolyzable substituent, each R² is independently a monovalent organic group, each R³ is independently an oxygen atom or a divalent hydrocarbon group, each subscript d is independently 1, 2, or 3, and subscript e is an integer having a value sufficient to provide the polydiorganosiloxane with a viscosity of at least 100 mPa·s at 25° C. and/or a DP of at least 87. DP may be measured by GPC using polystyrene calibration. Alternatively, subscript e may have a value ranging from 1 to 200,000.

Suitable hydrolyzable substituents for R¹ include, but are not limited to, the hydrolyzable substituents described above for group X. Alternatively, the hydrolyzable substituents for R¹ may be selected from a halogen atom, an acetamido group, an acyloxy group such as acetoxy, an alkoxy group, an amido group, an amino group, an aminoxy group, a hydroxyl group, an oximo group, a ketoximo group, and a methylacetamido group.

Suitable organic groups for R² include, but are not limited to, monovalent organic groups such as hydrocarbon groups and halogenated hydrocarbon groups. Examples of monovalent hydrocarbon groups for R² include, but are not limited to, alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl. Examples of monovalent halogenated hydrocarbon groups for R² include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Examples of other monovalent organic groups for R² include, but are not limited to, hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl. Alternatively, each R² may be an alkyl group such as methyl.

Ingredient (B) may comprise an α,ω-difunctional-polydiorganosiloxane when, in formula (I) above, each subscript d is 1 and each R³ is an oxygen atom. For example, ingredient (B) may have formula (II): R¹R²₂SiO-(R²₂SiO)ₑ′—SiR²₂R¹, where R¹ and R² are as described above and subscript e′ is an integer having a value sufficient to give the polydiorganosiloxane of formula (II) the viscosity described above. Alternatively, subscript e′ may have a value ranging from 1 to 200,000, alternatively 50 to 1,000, and alternatively 200 to 700.

Alternatively, ingredient (B) may comprise a hydroxyl-functional polydiorganosiloxane of formula (II) described above, in which each R¹ may be a hydroxyl group, each R² may be an alkyl group such as methyl, and subscript e′ may have a value such that the hydroxyl functional polydiorganosiloxane has a viscosity of at least 100 mPa·s at 25° C. Alternatively, subscript e′ may have a value ranging from 50 to 700. Exemplary hydroxyl-endblocked polydiorganosiloxanes are hydroxyl-endblocked polydimethylsiloxanes. Hydroxyl-endblocked polydiorganosiloxanes suitable for use as ingredient (B) may be prepared by methods known in the art, such as hydrolysis and condensation of the corresponding organohalosilanes or equilibration of cyclic polydiorganosiloxanes.

Alternatively, ingredient (B) may comprise an alkoxysilylhydrocarbylene-endblocked polydiorganosiloxane, for example, when in formula (I) above each R³ is divalent hydrocarbon group or a combination of a divalent hydrocarbon group and a divalent siloxane group. Each R³ may be an alkylene group such as ethylene, propylene, or hexylene; an arylene group such as phenylene, or an alkylarylene group such as:

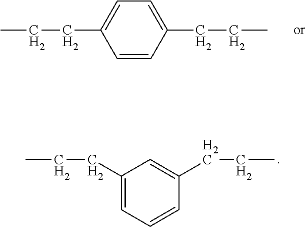

Alternatively, each R¹ and each R² may be alkyl, each R³ may be alkylene such as ethylene, and each subscript d may be 3.

Alkoxysilylhydrocarbylene-endblocked polydiorganosiloxanes may be prepared by reacting a vinyl-terminated, polydimethylsiloxane with (alkoxysilylhydrocarbyl)tetramethyldisiloxane.

### Organic Polymer

Alternatively, ingredient (B) may comprise a moisture-curable, silane-functional, organic polymer. Alternatively, the organic polymer may be a polymer in which at least half the atoms in the polymer backbone are carbon atoms with terminal moisture curable silyl groups containing hydrolyzable substituents bonded to silicon atoms. The organic polymer can, for example, be selected from hydrocarbon polymers, polyethers, acrylate polymers, polyurethanes and polyureas.

Ingredient (B) may be elastomeric, i.e., have a glass transition temperature (Tg) less than 0° C. When ingredient (B) is elastomeric, ingredient (B) may be distinguished from semi-crystalline and amorphous polyolefins (e.g., alpha-olefins), commonly referred to as thermoplastic polymers.

Ingredient (B) may comprise a silylated poly-alpha-olefin, a silylated copolymer of an iso-mono-olefin and a vinyl aromatic monomer, a silylated copolymer of a diene and a vinyl aromatic monomer, a silylated copolymer of an olefin and a diene (e.g., a silylated butyl rubber prepared from polyisobutylene and isoprene, which may optionally be halogenated), or a combination thereof (silylated copolymers), a silylated homopolymer of the iso-mono-olefin, a silylated homopolymer of the vinyl aromatic monomer, a silylated homopolymer of the diene (e.g., silylated polybutadiene or silylated hydrogenated polybutadiene), or a combination thereof (silylated homopolymers) or a combination silylated copolymers and silylated homopolymers. For purposes of this application, silylated copolymers and silylated homopolymers are referred to collectively as ‘silylated polymers’. The silylated polymer may optionally contain one or more halogen groups, particularly bromine groups.

Examples of suitable mono-iso-olefins include, but are not limited to, isoalkylenes such as isobutylene, isopentylene, isohexylene, and isoheptylene; alternatively isobutylene. Examples of suitable vinyl aromatic monomers include but are not limited to alkylstyrenes such as alpha-methylstyrene, t-butylstyrene, and para-methylstyrene; alternatively para-methylstyrene. Examples of suitable alkyl groups include methyl, ethyl, n-propyl, isopropyl, n-butyl, isobutyl, and t-butyl; alternatively methyl. Examples of suitable alkenyl groups include, vinyl, allyl, propenyl, butenyl, and hexenyl; alternatively vinyl. The silylated organic polymer may have Mn ranging from 20,000 to 500,000, alternatively 50,000-200,000, alternatively 20,000 to 100,000, alternatively 25,000 to 50,000, and alternatively 28,000 to 35,000; where values of Mn were measured by Triple Detection Size Exclusion Chromatography and calculated on the basis of polystyrene molecular weight standards.

Suitable examples of silylated poly-alpha-olefins are known in the art and are commercially available. Examples include the condensation reaction curable silylated polymers marketed as VESTOPLAST®, which are commercially available from Degussa AG Coatings & Colorants of Marl, Germany, Europe.

Briefly stated, a method for preparing the silylated copolymers involves contacting i) an olefin copolymer having at least 50 mole % of an iso-mono-olefin having 4 to 7 carbon atoms and a vinyl aromatic monomer; ii) a silane having at least two hydrolyzable groups and at least one olefinically unsaturated hydrocarbon or hydrocarbonoxy group; and iii) a free radical generating agent.

Alternatively, silylated copolymers may be prepared by a method comprising conversion of commercially available hydroxylated polybutadienes (such as those commercially available from Cray Valley SA of Paris, France, under trade names Poly BD and Krasol) by known methods (e.g., reaction with isocyanate functional alkoxysilane, reaction with allylchloride in presence of Na followed by hydrosilylation).

Alternatively, examples of silyl modified hydrocarbon polymers include silyl modified polyisobutylene, which is available commercially in the form of telechelic polymers. Silyl modified polyisobutylene can, for example, contain curable silyl groups derived from a silyl-substituted alkyl acrylate or methacrylate monomer such as a dialkoxyalkylsilylpropyl methacrylate or trialkoxysilylpropyl methacrylate, which can be reacted with a polyisobutylene prepared by living anionic polymerisation, atom transfer radical polymerization or chain transfer polymerization.

Alternatively, ingredient (B) may comprise a polyether. One type of polyether is a polyoxyalkylene polymer comprising recurring oxyalkylene units of the formula (—CₜH₂ₜ—O—) where subscript t is an integer with a value ranging from 2 to 4. Polyoxyalkylene polymers typically have terminal hydroxyl groups, and can readily be terminated with silyl groups having hydrolyzable substituents bonded to silicon atoms, for example by reaction with an excess of an alkyltrialkoxysilane to introduce terminal alkyldialkoxysilyl groups. Alternatively, polymerization may occur via a hydrosilylation type process. Polyoxyalkylenes comprising mostly oxypropylene units may have properties suitable for many sealant uses. Polyoxyalkylene polymers, particularly polyoxypropylenes, having terminal alkyldialkoxysilyl or trialkoxysilyl groups may react with each other in the presence of ingredient (A) and moisture. These base polymers may not require a separate crosslinker in the composition.

The organic polymer having hydrolysable silyl groups can alternatively be an acrylate polymer, that is an addition polymer of acrylate and/or methacrylate ester monomers, which may comprise at least 50% of the monomer units in the acrylate polymer. Examples of acrylate ester monomers are n-butyl, isobutyl, n-propyl, ethyl, methyl, n-hexyl, n-octyl and 2-ethylhexyl acrylates. Examples of methacrylate ester monomers are n-butyl, isobutyl, methyl, n-hexyl, n-octyl, 2-ethylhexyl and lauryl methacrylates. For some applications, the acrylate polymer may have a glass transition temperature (Tg) below ambient temperature; and acrylate polymers may form lower Tg polymers than methacrylate polymers. An exemplary acrylate polymer is polybutyl acrylate. The acrylate polymer may contain lesser amounts of other monomers such as styrene, acrylonitrile or acrylamide. The acrylate polymer can be prepared by various methods such as conventional radical polymerization, or living radical polymerization such as atom transfer radical polymerization, reversible addition-fragmentation chain transfer polymerization, or anionic polymerization including living anionic polymerization. The curable silyl groups can, for example, be derived from a silyl-substituted alkyl acrylate or methacrylate monomer. Hydrolysable silyl groups such as dialkoxyalkylsilyl or trialkoxysilyl groups can, for example, be derived from a dialkoxyalkylsilylpropyl methacrylate or trialkoxysilylpropyl methacrylate. When the acrylate polymer has been prepared by a polymerization process which forms reactive terminal groups, such as atom transfer radical polymerization, chain transfer polymerization, or living anionic polymerization, it can readily be reacted with the silyl-substituted alkyl acrylate or methacrylate monomer to form terminal hydrolyzable silyl groups.

Silyl modified polyurethanes or polyureas can, for example, be prepared by the reaction of polyurethanes or polyureas having terminal ethylenically unsaturated groups with a silyl monomer containing hydrolyzable groups and a Si—H group, for example a dialkoxyalkylsilicon hydride or trialkoxysilicon hydride.

### Silicone-Organic Block Copolymer

Alternatively, the base polymer may have a silicone-organic block copolymer backbone, which comprises at least one block of polyorganosiloxane groups and at least one block of an organic polymer chain. The polyorganosiloxane groups may comprise groups of formula

-(R⁴_{f}SiO_{(4-f)/2})—, in which each R⁴ is independently an organic group such as a hydrocarbon group having from 1 to 18 carbon atoms, a halogenated hydrocarbon group having from 1 to 18 carbon atoms such as chloromethyl, perfluorobutyl, trifluoroethyl, and nonafluorohexyl, a hydrocarbonoxy group having up to 18 carbon atoms, or another organic group exemplified by an oxygen atom containing group such as (meth)acrylic or carboxyl; a nitrogen atom containing group such as amino-functional groups, amido-functional groups, and cyano-functional groups; a sulfur atom containing group such as mercapto groups; and subscript f has, on average, a value ranging from 1 to 3, alternatively 1.8 to 2.2.

Alternatively, each R⁴ may be a hydrocarbon group having 1 to 10 carbon atoms or a halogenated hydrocarbon group; and subscript f may be 0, 1 or 2. Examples of groups suitable for R⁴ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group.

The organic blocks in the polymer backbone may comprise, for example, polystyrene and/or substituted polystyrenes such as poly(α-methylstyrene), poly(vinylmethylstyrene), dienes, poly(p-trimethylsilylstyrene) and poly(p-trimethylsilyl-α-methylstyrene). Other organic groups, which may be incorporated in the polymer backbone may include acetylene terminated oligophenylenes, vinylbenzyl terminated aromatic polysulphones oligomers, aromatic polyesters, aromatic polyester based monomers, polyalkylenes, polyurethanes, aliphatic polyesters, aliphatic polyamides and aromatic polyamides.

### Silicone Resin

Alternatively, ingredient (B) may comprise a silicone resin, in addition to, or instead of, one of the polymers described above for ingredient (B). Suitable silicone resins are exemplified by an MQ resin, which comprises siloxane units of the formulae:

R²⁹_{w}R³⁰_{(3-w)}SiO_{1/2} and SiO_{4/2}, where R²⁹ and R³⁰ are monovalent organic groups, such as monovalent hydrocarbon groups exemplified by alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl; halogenated hydrocarbon group exemplified by chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl; and other monovalent organic groups such as hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl; and each instance of subscript w is 0, 1, or 2. Alternatively, each R²⁹ and each R³⁰ may be an alkyl group. The MQ resin may have a molar ratio of M units to Q units (M:Q) ranging from 0.5:1 to 1.5:1. These mole ratios are conveniently measured by Si²⁹ NMR spectroscopy. This technique is capable of quantitatively determining the concentration of R²⁹₃ SiO_{1/2} (“M”) and SiO_{4/2} (“Q”) units derived from the silicone resin and from the neopentamer, Si(OSiMe₃)₄, present in the initial silicone resin, in addition to the total hydroxyl content of the silicone resin.

The MQ silicone resin is soluble in solvents such as liquid hydrocarbons exemplified by benzene, toluene, xylene, and heptane, or in liquid organosilicon compounds such as a low viscosity cyclic and linear polydiorganosiloxanes.

The MQ silicone resin may contain 2.0% or less, alternatively 0.7% or less, alternatively 0.3% or less, of terminal units represented by the formula X″SiO_{3/2}, where X″ represents hydroxyl or a hydrolyzable group such as alkoxy such as methoxy and ethoxy; alkenyloxy such as isopropenyloxy; ketoximo such as methyethylketoximo; carboxy such as acetoxy; amidoxy such as acetamidoxy; and aminoxy such as N,N-dimethylaminoxy. The concentration of silanol groups present in the silicone resin can be determined using FTIR.

The Mn required to achieve the desired flow characteristics of the MQ silicone resin will depend at least in part on the molecular weight of the silicone resin and the type of organic group, represented by R²⁹, that are present in this ingredient. The Mn of the MQ silicone resin is typically greater than 3,000, more typically from 4500 to 7500.

The MQ silicone resin can be prepared by any suitable method. Silicone resins of this type have reportedly been prepared by cohydrolysis of the corresponding silanes or by silica hydrosol capping methods known in the art. Briefly stated, the method involves reacting a silica hydrosol under acidic conditions with a hydrolyzable triorganosilane such as trimethylchlorosilane, a siloxane such as hexamethyldisiloxane, or a combination thereof, and recovering a product comprising M and Q units (MQ resin). The resulting MQ resins may contain from 2 to 5 percent by weight of silicon-bonded hydroxyl groups.

The intermediates used to prepare the MQ silicone resin may be triorganosilanes of the formula R²⁹₃SiX, where X represents a hydrolyzable group, as described above for ingredient (B), and either a silane with four hydrolyzable groups such as halogen, alkoxy or hydroxyl, or an alkali metal silicate such as sodium silicate.

In some compositions, it may be desirable that the silicon-bonded hydroxyl groups (i.e., HOR²⁹SiO_{1/2} or HOSiO_{3/2} groups) in the silicone resin be below 0.7% by weight of the total weight of the silicone resin, alternatively below 0.3%. Silicon-bonded hydroxyl groups formed during preparation of the silicone resin are converted to trihydrocarbylsiloxy groups or a hydrolyzable group by reacting the silicone resin with a silane, disiloxane or disilazane containing the appropriate terminal group. Silanes containing hydrolyzable groups may be added in excess of the quantity required to react with the silicon-bonded hydroxyl groups of the silicone resin.

Various suitable MQ resins are commercially available from sources such as Dow Corning Corporation of Midland, Mich., U.S.A., Momentive Performance Materials of Albany, N.Y., U.S.A., and Bluestar Silicones USA Corp. of East Brunswick, N.J., U.S.A. For example, DOW CORNING® MQ-1600 Solid Resin, DOW CORNING® MQ-1601 Solid Resin, and DOW CORNING® 1250 Surfactant, DOW CORNING® 7466 Resin, and DOW CORNING® 7366 Resin, all of which are commercially available from Dow Corning Corporation, are suitable for use in the methods described herein. Other examples of suitable MQ resins are disclosed in U.S. Pat. No. 5,082,706 to Tangney. Alternatively, a resin containing M, T, and Q units may be used, such as DOW CORNING® MQ-1640 Flake Resin, which is also commercially available from Dow Corning Corporation. Such resins may be supplied in organic solvent.

Alternatively, the silicone resin may comprise a silsesquioxane resin, i.e., a resin containing T units of formula (R³¹SiO_{3/2}). Each R³¹ may be independently selected from a hydrogen atom and a monovalent organic group, such as a monovalent hydrocarbon group exemplified by alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl; halogenated hydrocarbon group exemplified by chlorinated alkyl groups such as chloromethyl and chloropropyl groups; a fluorinated alkyl group such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl; and another monovalent organic group such as a hydrocarbon group substituted with oxygen atoms such as glycidoxyalkyl, and a hydrocarbon group substituted with a nitrogen atom such as aminoalkyl and cyano-functional groups such as cyanoethyl and cyanopropyl. Silsesquioxane resins suitable for use herein are known in the art and are commercially available. For example, a methylmethoxysiloxane methylsilsesquioxane resin having a DP of 15 and a weight average molecular weight (Mw) of 1200 is commercially available as DOW CORNING® US-CF 2403 Resin from Dow Corning Corporation of Midland, Mich., U.S.A. Alternatively, the silsesquioxane resin may have phenylsilsesquioxane units, methylsilsesquioxane units, or a combination thereof. Such resins are known in the art and are commercially available as DOW CORNING® 200 Flake resins, also available from Dow Corning Corporation. Alternatively, the silicone resin may comprise D units of formulae (R³¹₂SiO_{2/2}) and/or (R³¹R³²SiO_{2/2}) and T units of formulae (R³¹SiO_{3/2}) and/or (R³²SiO_{3/2}), i.e., a DT resin, where R³¹ is as described above and R³² is a hydrolyzable group such as group X described above. DT resins are known in the art and are commercially available, for example, methoxy functional DT resins include DOW CORNING® 3074 and DOW CORNING® 3037 resins; and silanol functional resins include DOW CORNING® 800 Series resins, which are also commercially available from Dow Corning Corporation. Other suitable resins include DT resins containing methyl and phenyl groups.

The amount of silicone resin added to the composition will vary depending on the end use of the composition. For example, when the reaction product of the composition is a gel, little or no silicone resin may be added. However, the amount of silicone resin in the composition may range from 0% to 90%, alternatively 0.1% to 50%, based on the weight of all ingredients in the composition.

The amount of ingredient (B) will depend on various factors including the end use of the reaction product of the composition, the type of base polymer selected for ingredient (B), and the type(s) and amount(s) of any additional ingredient(s) present, if any. However, the amount of ingredient (B) may range from 0.01% to 99%, alternatively 10% to 95%, alternatively 10% to 65% of the composition.

Ingredient (B) can be one single base polymer or a combination comprising two or more base polymers that differ in at least one of the following properties: average molecular weight, hydrolyzable substituents, siloxane units, sequence, and viscosity. When one base polymer for ingredient (B) contains an average of only one to two hydrolyzable substituents per molecule, then the composition further may further comprise an additional base polymer having an average of more than two hydrolyzable substituents per molecule, or ingredient (C) a crosslinker, or both.

Ingredient (A) may be selected based on various factors including the type of polymer backbone and/or hydrolyzable groups in ingredient (B). For example, when ingredient (B) has an organic polymer backbone, then ingredient (A) may comprise a polymeric phosphonate. Alternatively, when ingredient (B) has an organic polymer backbone, then ingredient (A) may comprise a combination of a silyl phosphonate and an organic phosphonate. When ingredient (B) has a silicone organic block copolymer backbone, then ingredient (A) may comprise a silyl phosphonate, an organic phosphonate, or a combination thereof. Alternatively, when ingredient (B) has a silicone organic block copolymer backbone, then ingredient (A) may comprise a polymeric phosphonate. Alternatively, when ingredient (B) has a polyorganosiloxane backbone, ingredient (A) may comprise a phosphonate of formula (I), above. Alternatively, when ingredient (B) has a polyorganosiloxane backbone, ingredient (A) may comprise an organic phosphonate, a silyl phosphonate, or a combination thereof. Alternatively, when ingredient (B) has a polyorganosiloxane backbone, ingredient (A) may comprise a combination of an organic phosphonate and a silyl phosphonate. Alternatively, when ingredient (B) has a polyorganosiloxane backbone, ingredient (A) may comprise a polymeric phosphonate.

### Additional Ingredients

The composition may optionally further comprise one or more additional ingredients, i.e., in addition to ingredients (A) and (B) and distinct from ingredients (A) and (B). The additional ingredient, if present, may be selected based on factors such as the method of use of the composition and/or the end use of the cured product of the composition. The additional ingredient may be: (C) a crosslinker; (D) a drying agent; (E) an extender, a plasticizer, or a combination thereof; (F) a filler such as (f1) a reinforcing filler, (f2) an extending filler, (f3) a conductive filler (e.g., electrically conductive, thermally conductive, or both); (G) a filler treating agent; (H) a biocide, such as (hl) a fungicide, (h2) an herbicide, (h3) a pesticide, or (h4) an antimicrobial; (J) a flame retardant; (K) a surface modifier such as (k1) an adhesion promoter or (k2) a release agent; (L) a chain lengthener; (M) an endblocker; (N) a nonreactive binder; (O) an anti-aging additive; (P) a water release agent; (Q) a pigment; (R) a rheological additive; (S) a solvent; (T) a tackifying agent; and a combination thereof.

### Ingredient (C) Crosslinker

Ingredient (C) is a crosslinker that may be added to the composition, for example, when ingredient (B) contains an average of only one or two hydrolyzable substituents per molecule and/or to increase crosslink density of the reaction product prepared by condensation reaction of the composition. Generally, ingredient (C) is selected with functionality that will vary depending on the degree of crosslinking desired in the reaction product of the composition and such that the reaction product does not exhibit too much weight loss from by-products of the condensation reaction. Generally, the selection of ingredient (C) is made such that the composition remains sufficiently reactable to be useful during storage for several months in a moisture impermeable package. The exact amount of ingredient (C) will vary depending on factors including the type of base polymer and crosslinker selected, the reactivity of the hydrolyzable substituents on the base polymer and crosslinker, and the desired crosslink density of the reaction product. However, the amount of crosslinker may range from 0.5 to 100 parts based on 100 parts by weight of ingredient (B).

Ingredient (C) may comprise a silane crosslinker having hydrolyzable groups or partial or full hydrolysis products thereof. Ingredient (C) has an average, per molecule, of greater than two substituents reactive with the hydrolyzable substituents on ingredient (B). Examples of suitable silane crosslinkers for ingredient (C) may have the general formula (III) R⁸ₖSi(R⁹)₍₄₋ₖ₎, where each R⁸ is independently a monovalent hydrocarbon group such as an alkyl group; each R⁹ is a hydrolyzable substituent, which may be the same as X described above for ingredient (B). Alternatively, each R⁹ may be, for example, a halogen atom, an acetamido group, an acyloxy group such as acetoxy, an alkoxy group, an amido group, an amino group, an aminoxy group, a hydroxyl group, an oximo group, a ketoximo group, or a methylacetamido group; and each instance of subscript k may be 0, 1, 2, or 3. For ingredient (C), subscript k has an average value greater than 2. Alternatively, subscript k may have a value ranging from 3 to 4. Alternatively, each R⁹ may be independently selected from hydroxyl, alkoxy, acetoxy, amide, or oxime. Alternatively, ingredient (C) may be selected from an acyloxysilane, an alkoxysilane, a ketoximosilane, and an oximosilane.

Ingredient (C) may comprise an alkoxysilane exemplified by a dialkoxysilane, such as a dialkyldialkoxysilane; a trialkoxysilane, such as an alkyltrialkoxysilane; a tetraalkoxysilane; or partial or full hydrolysis products thereof, or another combination thereof. Examples of suitable trialkoxysilanes include methyltrimethoxysilane, methyltriethoxysilane, ethyltrimethoxysilane, ethyltriethoxysilane, isobutyltrimethoxysilane, isobutyltriethoxysilane, and a combination thereof, and alternatively methyltrimethoxysilane. Examples of suitable tetraalkoxysilanes include tetraethoxysilane. The amount of the alkoxysilane that is used in the curable silicone composition may range from 0.5 to 15, parts by weight per 100 parts by weight of ingredient (B).

Ingredient (C) may comprise an acyloxysilane, such as an acetoxysilane. Acetoxysilanes include a tetraacetoxysilane, an organotriacetoxysilane, a diorganodiacetoxysilane, or a combination thereof. The acetoxysilane may contain alkyl groups such as methyl, ethyl, propyl, isopropyl, butyl, and tertiary butyl; alkenyl groups such as vinyl, allyl, or hexenyl; aryl groups such as phenyl, tolyl, or xylyl; aralkyl groups such as benzyl or 2-phenylethyl; and fluorinated alkyl groups such as 3,3,3-trifluoropropyl. Exemplary acetoxysilanes include, but are not limited to, tetraacetoxysilane, methyltriacetoxysilane, ethyltriacetoxysilane, vinyltriacetoxysilane, propyltriacetoxysilane, butyltriacetoxysilane, phenyltriacetoxysilane, octyltriacetoxysilane, dimethyldiacetoxysilane, phenylmethyldiacetoxysilane, vinylmethyldiacetoxysilane, diphenyl diacetoxysilane, tetraacetoxysilane, and combinations thereof. Alternatively, ingredient (C) may comprise organotriacetoxysilanes, for example mixtures comprising methyltriacetoxysilane and ethyltriacetoxysilane. The amount of the acetoxysilane that is used in the curable silicone composition may range from 0.5 to 15 parts by weight per 100 parts by weight of ingredient (B); alternatively 3 to 10 parts by weight of acetoxysilane per 100 parts by weight of ingredient (B).

Examples of silanes suitable for ingredient (C) containing both alkoxy and acetoxy groups that may be used in the composition include methyldiacetoxymethoxysilane, methylacetoxydimethoxysilane, vinyldiacetoxymethoxysilane, vinylacetoxydimethoxysilane, methyldiacetoxyethoxysilane, methylacetoxydiethoxysilane, and combinations thereof.

Aminofunctional alkoxysilanes suitable for ingredient (C) are exemplified by H₂N(CH₂)₂Si(OCH₃)₃, H₂N(CH₂)₂Si(OCH₂CH₃)₃, H₂N(CH₂)₃Si(OCH₃)₃, H₂N(CH₂)₃Si(OCH₂CH₃)₃, CH₃NH(CH₂)₃Si(OCH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃Si(OCH₂CH₃)₃, CH₃NH(CH₂)₂NH(CH₂)₃Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₃SiCH₃(OCH₂CH₃)₂, CH₃NH(CH₂)₅SiCH₃(OCH₃)₂, CH₃NH(CH₂)₅SiCH₃(OCH₂CH₃)₂, H₂N(CH₂)₂NH(CH₂)₃SiCH₃(OCH₃)₂, H₂N(CH₂)₂NH(CH₂)₃SiCH₃(OCH₂CH₃)₂, CH₃NH(CH₂)₂NH(CH₂)₃SiCH₃(OCH₃)₂, CH₃NH(CH₂)₂NH(CH₂)₃ SiCH₃ (OCH₂CH₃)₂, C₄H₉NH(CH₂)₂NH(CH₂)₃ SiCH₃ (OCH₃)₂, C₄H₉NH(CH₂)₂NH(CH₂)₃SiCH₃(OCH₂CH₃)₂, and a combination thereof.

Suitable oximosilanes for ingredient (C) include alkyltrioximosilanes such as methyltrioximosilane, ethyltrioximosilane, propyltrioximosilane, and butyltrioximosilane; alkoxytrioximosilanes such as methoxytrioximosilane, ethoxytrioximosilane, and propoxytrioximosilane; or alkenyltrioximosilanes such as propenyltrioximosilane or butenyltrioximosilane; alkenyloximosilanes such as vinyloximosilane; alkenylalkyldioximosilanes such as vinyl methyl dioximosilane, vinyl ethyldioximosilane, vinyl methyldioximosilane, or vinylethyldioximosilane; or combinations thereof.

Suitable ketoximosilanes for ingredient (C) include methyl tris(dimethylketoximo)silane, methyl tris(methylethylketoximo)silane, methyl tris(methylpropylketoximo)silane, methyl tris(methylisobutylketoximo)silane, ethyl tris(dimethylketoximo)silane, ethyl tris(methylethylketoximo)silane, ethyl tris(methylpropylketoximo)silane, ethyl tris(methylisobutylketoximo)silane, vinyl tris(dimethylketoximo)silane, vinyl tris(methylethylketoximo)silane, vinyl tris(methylpropylketoximo)silane, vinyl tris(methylisobutylketoximo)silane, tetrakis(dimethylketoximo)silane, tetrakis(methylethylketoximo)silane, tetrakis(methylpropylketoximo)silane, tetrakis(methylisobutylketoximo)silane, methylbis(dimethylketoximo)silane, methylbis(cyclohexylketoximo)silane, triethoxy(ethylmethylketoxime)silane, diethoxydi(ethylmethylketoxime)silane, ethoxytri(ethylmethylketoxime)silane, methylvinylbis(methylisobutylketoximo)silane, or a combination thereof.

Alternatively, ingredient (C) may be polymeric. For example, ingredient (C) may comprise a disilane such as bis(triethoxysilyl)hexane), 1,4-bis[trimethoxysilyl(ethyl)]benzene, and bis[3-(triethoxysilyl)propyl]tetrasulfide

Ingredient (C) can be one single crosslinker or a combination comprising two or more crosslinkers that differ in at least one of the following properties: hydrolyzable substituents and other organic groups bonded to silicon, and when a polymeric crosslinker is used, siloxane units, structure, molecular weight, and sequence.

### Ingredient (D) Drying Agent

Ingredient (D) is a drying agent. The drying agent binds water from various sources. For example, the drying agent may bind by-products of the condensation reaction, such as water and alcohols.

Examples of suitable adsorbents for ingredient (D) may be inorganic particulates. The adsorbent may have a particle size of 10 micrometers or less, alternatively 5 micrometers or less. The adsorbent may have average pore size sufficient to adsorb water and alcohols, for example 10 Å(Angstroms) or less, alternatively 5 Å or less, and alternatively 3 Å or less. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof. One skilled in the art would be able to select suitable drying agents for ingredient (D) without undue experimentation. One skilled in the art would recognize that certain drying agents such as silica gel will bind water, while others such as molecular sieves may bind water, alcohols, or both.

Examples of commercially available drying agents include dry molecular sieves, such as 3 Å (Angstrom) molecular sieves, which are commercially available from Grace Davidson under the trademark SYLOSIV® and from Zeochem of Louisville, Ky., U.S.A. under the trade name PURMOL, and 4 Å molecular sieves such as Doucil zeolite 4A available from Ineos Silicas of Warrington, England. Other useful molecular sieves include MOLSIV ADSORBENT TYPE 13X, 3A, 4A, and 5A, all of which are commercially available from UOP of Illinois, U.S.A.; SILIPORITE NK 30AP and 65xP from Atofina of Philadelphia, Pa., U.S.A.; and molecular sieves available from W.R. Grace of Maryland, U.S.A.

Alternatively, the drying agent may bind the water and/or other by-products by chemical means. An amount of a silane crosslinker added to the composition (in addition to ingredient (C)) may function as a chemical drying agent. Without wishing to be bound by theory, it is thought that the chemical drying agent may be added to the dry part of a multiple part composition to keep the composition free from water after the parts of the composition are mixed together. For example, alkoxysilanes suitable as drying agents include vinyltrimethoxysilane, vinyltriethoxysilane, and combinations thereof.

The amount of ingredient (D) depends on the specific drying agent selected. However, when ingredient (D) is a chemical drying agent, the amount may range from 0 parts to 5 parts, alternatively 0.1 parts to 0.5 parts. Ingredient (D) may be one chemical drying agent. Alternatively, ingredient (D) may comprise two or more different chemical drying agents.

### Ingredient (E)

Ingredient (E) is an extender and/or a plasticizer. An extender comprising a non-functional polyorganosiloxane may be used in the composition. For example, the non-functional polyorganosiloxane may comprise difunctional units of the formula R²²₂SiO_{2/2} and terminal units of the formula R²³₃SiD′-, where each R²² and each R²³ are independently a monovalent organic group such as a monovalent hydrocarbon group exemplified by alkyl such as methyl, ethyl, propyl, and butyl; alkenyl such as vinyl, allyl, and hexenyl; aryl such as phenyl, tolyl, xylyl, and naphthyl; and aralkyl groups such as phenylethyl; and D′ is an oxygen atom or a divalent group linking the silicon atom of the terminal unit with another silicon atom (such as group D described above for ingredient (B)), alternatively D′ is an oxygen atom. Non-functional polyorganosiloxanes are known in the art and are commercially available. Suitable non-functional polyorganosiloxanes are exemplified by, but not limited to, polydimethylsiloxanes. Such polydimethylsiloxanes include DOW CORNING® 200 Fluids, which are commercially available from Dow Corning Corporation of Midland, Mich., U.S.A. and may have viscosity ranging from 50 cSt to 100,000 cSt, alternatively 50 cSt to 50,000 cSt, and alternatively 12,500 to 60,000 cSt.

An organic plasticizer may be used in addition to, or instead of, the non-functional polyorganosiloxane extender described above. Organic plasticizers are known in the art and are commercially available. The organic plasticizer may comprise a phthalate, a carboxylate, a carboxylic acid ester, an adipate or a combination thereof. The organic plasticizer may be selected from the group consisting of: bis(2-ethylhexyl)terephthalate; bis(2-ethylhexyl)-1,4-benzenedicarboxylate; 2-ethylhexyl methyl-1,4-benzenedicarboxylate; 1,2 cyclohexanedicarboxylic acid, dinonyl ester, branched and linear; bis(2-propylheptyl) phthalate; diisononyl adipate; and a combination thereof.

The organic plasticizer may have an average, per molecule, of at least one group of formula

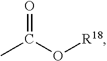

where R¹⁸ represents a hydrogen atom or a monovalent organic group. Alternatively, R¹⁸ may represent a branched or linear monovalent hydrocarbon group. The monovalent organic group may be a branched or linear monovalent hydrocarbon group such as an alkyl group of 4 to 15 carbon atoms, alternatively 9 to 12 carbon atoms. Suitable plasticizers may be selected from the group consisting of adipates, carboxylates, phthalates, and a combination thereof.

Alternatively, the organic plasticizer may have an average, per molecule, of at least two groups of the formula above bonded to carbon atoms in a cyclic hydrocarbon. The organic plasticizer may have general formula:

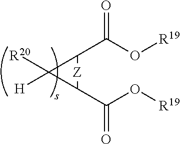

In this formula, group Z represents a cyclic hydrocarbon group having 3 or more carbon atoms, alternatively 3 to 15 carbon atoms. Subscript s may have a value ranging from 1 to 12. Group Z may be saturated or aromatic. Each R²⁰ is independently a hydrogen atom or a branched or linear monovalent organic group. The monovalent organic group for R¹⁹ may be an alkyl group such as methyl, ethyl, or butyl. Alternatively, the monovalent organic group for R²⁰ may be an ester functional group. Each R¹⁹ is independently a branched or linear monovalent hydrocarbon group, such as an alkyl group of 4 to 15 carbon atoms.

Suitable organic plasticizers are known in the art and are commercially available. The plasticizer may comprise a phthalate, such as: a dialkyl phthalate such as dibutyl phthalate, diheptyl phthalate, di(2-ethylhexyl) phthalate, or diisodecyl phthalate (DIDP), bis(2-propylheptyl) phthalate, di(2-ethylhexyl) phthalate, dimethyl phthalate; diethyl phthalate; butyl benzyl phthalate, and bis(2-ethylhexyl) terephthalate; a dicarboxylate such as 1,2,4-benzenetricarboxylic acid, bis(2-ethylhexyl)-1,4-benzenedicarboxylate; 2-ethylhexyl methyl-1,4-benzenedicarboxylate; 1,2 cyclohexanedicarboxylic acid, dinonyl ester, branched and linear; diisononyl adipate; trimellitates such as trioctyl trimellitate; triethylene glycol bis(2-ethylhexanoate); triacetin; nonaromatic dibasic acid esters such as dioctyl adipate, bis(2-ethylhexyl) adipate, di-2-ethylhexyladipate, dioctyl sebacate, dibutyl sebacate and diisodecyl succinate; aliphatic esters such as butyl oleate and methyl acetyl recinolate; phosphates such as tricresyl phosphate and tributyl phosphate; chlorinated paraffins; hydrocarbon oils such as alkyldiphenyls and partially hydrogenated terphenyls; process oils; epoxy plasticizers such as epoxidized soybean oil and benzyl epoxystearate; tris(2-ethylhexyl) ester; a fatty acid ester; and a combination thereof. Examples of suitable plasticizers and their commercial sources include those listed below in the table below.

### Table of Exemplary Organic Plasticizers and Commercial Sources

| Product Name | % | Component |
|---|---|---|
| Eastman(TM) 425 Plasticizer | 75% | bis(2-ethylhexyl) terephthalate |
| Eastman(TM) 168 Plasticizer | >98% | bis(2-ethylhexyl)-1,4- |
| | | benzenedicarboxylate |
| | <2% | 2-ethylhexyl methyl-1,4- |
| | | benzenedicarboxylate |
| Eastman(TM) 168-CA Plasticizer | >97% | bis(2-ethylhexyl)-1,4- |
| | | benzenedicarboxylate |
| | <2% | 2-ethylhexyl methyl-1,4- |
| | | benzenedicarboxylate |
| BASF Hexamoll *DINCH | >99.5% | 1,2 cyclohexanedicarboxylic acid, |
| | | dinonyl ester, |
| | | branched and linear |
| BASF Palatinol ® DPHP | 99.9% | bis(2-propylheptyl) phthalate or Di- |
| | | (2-Propyl Heptyl) Phthalate |
| BASF Palamoll ® 652 | 96.0% | PMN00-0611 |
| | 4.0% | diisononyl adipate |
| Eastman 168 Xtreme (TM) | 100% | Plasticizer |
| Plasticizer | | |
| Eastman(TM) TOTM Plasticize | >99.9% | trioctyl trimellitate |
| Eastman(TM) TEG-EH Plasticizer | 100% | triethylene glycol bis(2- |
| | | ethylhexanoate) |
| Eastman(TM) DOP Plasticizer | 100% | di(2-ethylhexyl) phthalate |
| Eastman(TM) Triacetin | 100% | Triacetin |
| Eastman(TM) DOA Plasticizer | 100% | bis(2-ethylhexyl) adipate |
| Eastman(TM) DOA Plasticizer, | 100% | bis(2-ethylhexyl) adipate |
| Kosher | | |
| Eastman(TM) DMP Plasticizer | 100% | dimethyl phthalate |
| Eastman(TM) DEP Plasticizer | 100% | diethyl phthalate |
| Eastman(TM) DBP Plasticizer | 100% | dibutyl phthalate |
| BASF Plastomoll ® DOA | >99.5% | Di-2-ethylhexyladipate |
| BASF Palatinol ® TOTM-I | >99% | 1,2,4-Benzenetricarboxylic acid, |
| | | tris(2-ethylhexyl) ester |
| Ferro SANTICIZER ® 261A | >99.5% | Benzyl, C7-C9 linear and branched |
| | | alkyl esters, 1,2,benzene |
| | | dicarboxylic acid |

Alternatively, a polymer plasticizer can be used. Examples of the polymer plasticizer include alkenyl polymers obtained by polymerizing vinyl or allyl monomers by means of various methods; polyalkylene glycol esters such as diethylene glycol dibenzoate, triethylene glycol dibenzoate and pentaerythritol ester; polyester plasticizers obtained from dibasic acids such as sebacic acid, adipic acid, azelaic acid and phthalic acid and dihydric alcohols such as ethylene glycol, diethylene glycol, triethylene glycol, propylene glycol and dipropylene glycol; polyethers including polyether polyols each having a molecular weight of not less than 500 such as polyethylene glycol, polypropylene glycol and polytetramethylene glycol, polystyrenes such as polystyrene and poly-alpha-methylstyrene; and polybutadiene, polybutene, polyisobutylene, butadiene acrylonitrile, and polychloroprene.

When the organic plasticizer is present, the amount of the organic plasticizer may range from 5 to 150 parts by weight based on the combined weights of all ingredients in the composition.

The polyorganosiloxane extenders and organic plasticizers described above for ingredient (E) may be used either each alone or in combinations of two or more thereof. A low molecular weight organic plasticizer and a higher molecular weight polymer plasticizer may be used in combination. The exact amount of ingredient (E) used in the composition will depend on various factors including the desired end use of the composition and the cured product thereof. However, the amount of ingredient (E) may range from 0.1% to 10% based on the combined weights of all ingredients in the composition.

### Ingredient (F) Filler

Ingredient (F) is a filler. The filler may comprise a reinforcing filler, an extending filler, a conductive filler, or a combination thereof. For example, the composition may optionally further comprise ingredient (f1), a reinforcing filler, which when present may be added in an amount ranging from 0.1% to 95%, alternatively 1% to 60%, based on the weight of the composition. The exact amount of ingredient (f1) depends on various factors including the form of the reaction product of the composition and whether any other fillers are added. Examples of suitable reinforcing fillers include reinforcing silica fillers such as fume silica, silica aerogel, silica xerogel, and precipitated silica. Fumed silicas are known in the art and commercially available; e.g., fumed silica sold under the name CAB-O-SIL by Cabot Corporation of Massachusetts, U.S.A.

The composition may optionally further comprise ingredient (f2) an extending filler in an amount ranging from 0.1% to 95%, alternatively 1% to 60%, and alternatively 1% to 20%, based on the weight of the composition. Examples of extending fillers include crushed quartz, aluminum oxide, magnesium oxide, calcium carbonate such as precipitated calcium carbonate, zinc oxide, talc, diatomaceous earth, iron oxide, clays, mica, chalk, titanium dioxide, zirconia, sand, carbon black, graphite, or a combination thereof. Extending fillers are known in the art and commercially available; such as a ground silica sold under the name MIN-U-SIL by U.S. Silica of Berkeley Springs, W. Va. Suitable precipitated calcium carbonates included Winnofil® SPM from Solvay and Ultrapflex® and Ultrapflex® 100 from SMI.

The composition may optionally further comprise ingredient (f3) a conductive filler. Conductive fillers may be thermally conductive, electrically conductive, or both. Conductive fillers are known in the art and are exemplified by metal particulates (such as aluminum, copper, gold, nickel, silver, and combinations thereof); such metals coated on nonconductive substrates; metal oxides (such as aluminum oxide, beryllium oxide, magnesium oxide, zinc oxide, and combinations thereof), meltable fillers (e.g., solder), aluminum nitride, aluminum trihydrate, barium titanate, boron nitride, carbon fibers, diamond, graphite, magnesium hydroxide, onyx, silicon carbide, tungsten carbide, and a combination thereof.

Alternatively, other fillers may be added to the composition, the type and amount depending on factors including the end use of the cured product of the composition. Examples of such other fillers include magnetic particles such as ferrite; and dielectric particles such as fused glass microspheres, titania, and calcium carbonate.

### Ingredient (G) Treating Agent

The composition may optionally further comprise ingredient (G) a treating agent. The amount of ingredient (G) will vary depending on factors such as the type of treating agent selected and the type and amount of particulates to be treated, and whether the particulates are treated before being added to the composition, or whether the particulates are treated in situ. However, ingredient (G) may be used in an amount ranging from 0.01% to 20%, alternatively 0.1% to 15%, and alternatively 0.5% to 5%, based on the weight of the composition. Particulates, such as the filler, the physical drying agent, certain flame retardants, certain pigments, and/or certain water release agents, when present, may optionally be surface treated with ingredient (G). Particulates may be treated with ingredient (G) before being added to the composition, or in situ. Ingredient (G) may comprise an alkoxysilane, an alkoxy-functional oligosiloxane, a cyclic polyorganosiloxane, a hydroxyl-functional oligosiloxane such as a dimethyl siloxane or methyl phenyl siloxane, or a fatty acid. Examples of fatty acids include stearates such as calcium stearate.

Some representative organosilicon filler treating agents that can be used as ingredient (G) include compositions normally used to treat silica fillers such as organochlorosilanes, organosiloxanes, organodisilazanes such as hexaalkyl disilazane, and organoalkoxysilanes such as C₆H₁₃Si(OCH₃)₃, C₈H₁₇Si(OC₂H₅)₃, C₁₀H₂₁Si(OCH₃)₃, C₁₂H₂₅Si(OCH₃)₃, C₁₄H₂₉Si(OC₂H₅)₃, and C₆H₅CH₂CH₂Si(OCH₃)₃. Other treating agents that can be used include alkylthiols, fatty acids, titanates, titanate coupling agents, zirconate coupling agents, and combinations thereof.

Alternatively, ingredient (G) may comprise an alkoxysilane having the formula: R¹³ₒSi(OR¹⁴)₍₄₋ₚ₎, where subscript p may have a value ranging from 1 to 3, alternatively subscript p is 3. Each R¹³ is independently a monovalent organic group, such as a monovalent hydrocarbon group of 1 to 50 carbon atoms, alternatively 8 to 30 carbon atoms, alternatively 8 to 18 carbon atoms. R¹³ is exemplified by alkyl groups such as hexyl, octyl, dodecyl, tetradecyl, hexadecyl, and octadecyl; and aromatic groups such as benzyl and phenylethyl. R¹³ may be saturated or unsaturated, and branched or unbranched. Alternatively, R¹³ may be saturated and unbranched.

Each R¹⁴ is independently a saturated hydrocarbon group of 1 to 4 carbon atoms, alternatively 1 to 2 carbon atoms. Ingredient (G) is exemplified by hexyltrimethoxysilane, octyltriethoxysilane, decyltrimethoxysilane, dodecyltrimethoxysilane, tetradecyltrimethoxysilane, phenylethyltrimethoxysilane, octadecyltrimethoxysilane, octadecyltriethoxysilane, and combinations thereof.

Alkoxy-functional oligosiloxanes may also be used as treating agents. For example, suitable alkoxy-functional oligosiloxanes include those of the formula (R¹⁵O)_{q}Si(OSiR¹⁶₂R¹⁷)_{(4-q)}. In this formula, subscript q is 1, 2 or 3, alternatively subscript q is 3. Each R¹⁵ may be an alkyl group. Each R¹⁶ may be an unsaturated monovalent hydrocarbon group of 1 to 10 carbon atoms. Each R¹⁷ may be an unsaturated monovalent hydrocarbon group having at least 10 carbon atoms.

Certain particulates, such as metal fillers may be treated with alkylthiols such as octadecyl mercaptan; fatty acids such as oleic acid and stearic acid; and a combination thereof.

Other treating agents include alkenyl functional polyorganosiloxanes. Suitable alkenyl functional polyorganosiloxanes include, but are not limited to:

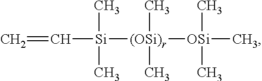

where subscript r has a value up to 1,500.

Alternative, a polyorganosiloxane capable of hydrogen bonding is useful as a treating agent. This strategy to treating surface of a filler takes advantage of multiple hydrogen bonds, either clustered or dispersed or both, as the means to tether the compatibilization moiety to the filler surface. The polyorganosiloxane capable of hydrogen bonding has an average, per molecule, of at least one silicon-bonded group capable of hydrogen bonding. The group may be selected from: an organic group having multiple hydroxyl functionalities or an organic group having at least one amino functional group. The polyorganosiloxane capable of hydrogen bonding means that hydrogen bonding is the primary mode of attachment for the polyorganosiloxane to a filler. The polyorganosiloxane may be incapable of forming covalent bonds with the filler. The polyorganosiloxane may be free of condensable silyl groups e.g., silicon bonded alkoxy groups, silazanes, and silanols. The polyorganosiloxane capable of hydrogen bonding may be selected from the group consisting of a saccharide-siloxane polymer, an amino-functional polyorganosiloxane, and a combination thereof. Alternatively, the polyorganosiloxane capable of hydrogen bonding may be a saccharide-siloxane polymer.

### Ingredient (H) Biocide

Ingredient (H) is a biocide. The amount of ingredient (H) will vary depending on factors including the type of biocide selected and the benefit desired. However, the amount of ingredient (H) may range from greater than 0% to 5% based on the weight of all ingredients in the composition. Ingredient (H) is exemplified by (h1) a fungicide, (h2) an herbicide, (h3) a pesticide, or a combination thereof.

Ingredient (h1) is a fungicide, for example, these include N-substituted benzimidazole carbamate, benzimidazolyl carbamate such as methyl 2-benzimidazolylcarbamate, ethyl 2-benzimidazolylcarbamate, isopropyl 2-benzimidazolylcarbamate, methyl N-{2-[1-(N,N-dimethylcarbamoyl)benzimidazolyl}]carbamate, methyl N-{2-[1-(N,N-dimethylcarbamoyl)-6-methylbenzimidazolyl]}carbamate, methyl N-{2-[1-(N,N-dimethylcarbamoyl)-5-methylbenzimidazolyl]}carbamate, methyl N-{2-[1-(N-methylcarbamoyl)benzimidazolyl]}carbamate, methyl N-{2-[1-(N-methylcarbamoyl)-6-methylbenzimidazolyl]}carbamate, methyl N-{2-[1-(N-methylcarbamoyl)-5-methylbenzimidazolyl]}carbamate, ethyl N-{2-[1-(N,N-dimethylcarbamoyl)benzimidazolyl]}carbamate, ethyl N-{2-[2-(N-methylcarbamoyl)benzimidazolyl]}carbamate, ethyl N-{2-[1-(N,N-dimethylcarbamoyl)-6-methylbenzimidazolyl]}carbamate, ethyl N-{2-[1-(N-methylcarbamoyl)-6-methylbenzimidazolyl]}carbamate, isopropyl N-{2-[1-(N,N-dimethylcarbamoyl)benzimidazolyl]}carbamate, isopropyl N-{2-[1-(N-methylcarbamoyl)benzimidazolyl]}carbamate, methyl N-{2-[1-(N-propylcarbamoyl)benzimidazolyl]}carbamate, methyl N-{2-[1-(N-butylcarbamoyl)benzimidazolyl]}carbamate, methoxyethyl N-{2-[1-(N-propylcarbamoyl)benzimidazoly]}carbamate, methoxyethyl N-{2-[1-(N-butylcarbamoyl)benzimidazolyl]}carbamate, ethoxyethyl N-{2-[1-(N-propylcarbamoyl)benzimidazolyl]}carbamate, ethoxyethyl N-{2-[1-(N-butylcarbamoyl)benzimidazolyl]}carbamate, methyl N-{1-(N,N-dimethylcarbamoyloxy)benzimidazolyl]}carbamate, methyl N-{2-[N-methylcarbamoyloxy)benzimidazolyl]}carbamate, methyl N-{2-[1-(N-butylcarbamoyloxy)benzoimidazolyl]}carbamate, ethoxyethyl N-{2-[1-(N-propylcarbamoyl)benzimidazolyl]}carbamate, ethoxyethyl N-{2-[1-(N-butylcarbamoyloxy)benzoimidazolyl]}carbamate, methyl N-{2-[1-(N,N-dimethylcarbamoyl)-6-chlorobenzimidazolyl]}carbamate, and methyl N-{2-[1-(N,N-dimethylcarbamoyl)-6-nitrobenzimidazolyl]}carbamate; 10,10′-oxybisphenoxarsine (trade name: Vinyzene, OBPA), di-iodomethyl-para-tolylsulfone, benzothiophene-2-cyclohexylcarboxamide-S,S-dioxide, N-(fluordichloridemethylthio)phthalimide (trade names: Fluor-Folper, Preventol A3); methyl-benzimideazol-2-ylcarbamate (trade names: Carbendazim, Preventol BCM), Zinc-bis(2-pyridylthio-1-oxide) (zinc pyrithion) 2-(4-thiazolyl)-benzimidazol, N-phenyl-iodpropargylcarbamate, N-octyl-4-isothiazolin-3-on, 4,5-dichloride-2-n-octyl-4-isothiazolin-3-on, N-butyl-1,2-benzisothiazolin-3-on and/or Triazolyl-compounds, such as tebuconazol in combination with zeolites containing silver.

Ingredient (h2) is an herbicide, for example, suitable herbicides include amide herbicides such as allidochlor N,N-diallyl-2-chloroacetamide; CDEA 2-chloro-N,N-diethylacetamide; etnipromid (RS)-2-[5-(2,4-dichlorophenoxy)-2-nitrophenoxy]-N-ethylpropionamide; anilide herbicides such as cisanilide cis-2,5-dimethylpyrrolidine-1-carboxanilide; flufenacet 4′-fluoro-N-isopropyl-2-[5-(trifluoromethyl)-1,3,4-thiadiazol-2-yloxy]acetanilide; naproanilide (RS)-α-2-naphthoxypropionanilide; arylalanine herbicides such as benzoylprop N-benzoyl-N-(3,4-dichlorophenyl)-DL-alanine; flamprop-M N-benzoyl-N-(3-chloro-4-fluorophenyl)-D-alanine; chloroacetanilide herbicides such as butachlor N-butoxymethyl-2-chloro-2′,6′-diethylacetanilide; metazachlor 2-chloro-N-(pyrazol-1-ylmethyl)acet-2′,6′-xylidide; prynachlor (RS)-2-chloro-N-(1-methylprop-2-ynyl)acetanilide; sulphonanilide herbicides such as cloransulam 3-chloro-2-(5-ethoxy-7-fluoro[1,2,4]triazolo[1,5-c]pyrimidin-2-ylsulphonamido)benzoic acid; metosulam 2′,6′-dichloro-5,7-dimethoxy-3′-methyl[1,2,4]-triazolo[1,5-α]pyrimidine-2-sulphonanilide; antibiotic herbicides such as bilanafos 4-[hydroxy(methyl)phosphinoyl]-L-homoalanyl-L-alanyl-L-alanine; benzoic acid herbicides such as chloramben 3-amino-2,5-dichlorobenzoic acid; 2,3,6-TBA 2,3,6-trichlorobenzoic acid; pyrimidinyloxybenzoic acid herbicides such as bispyribac 2,6-bis(4,6-dimethoxypyrimidin-2-yloxy)benzoic acid; pyrimidinylthiobenzoic acid herbicides such as pyrithiobac 2-chloro-6-(4,6-dimethoxypyrimidin-2-ylthio)benzoic acid; phthalic acid herbicides such as chlorthal tetrachloroterephthalic acid; picolinic acid herbicides such as aminopyralid 4-amino-3,6-dichloropyridine-2-carboxylic acid; quinolinecarboxylic acid herbicides such as quinclorac 3,7-dichloroquinoline-8-carboxylic acid; arsenical herbicides such as CMA calcium bis(hydrogen methylarsonate); MAMA ammonium hydrogen methylarsonate; sodium arsenite; benzoylcyclohexanedione herbicides such as mesotrione 2-(4-mesyl-2-nitrobenzoyl)cyclohexane-1,3-dione; benzofuranyl alkylsulphonate herbicides such as benfuresate 2,3-dihydro-3,3-dimethylbenzofuran-5-yl ethanesulphonate; carbamate herbicides such as carboxazole methyl 5-tert-butyl-1,2-oxazol-3-ylcarbamate; fenasulam methyl 4-[2-(4-chloro-o-tolyloxy)acetamido]phenylsulphonylcarbamate; carbanilate herbicides such as BCPC(RS)-sec-butyl 3-chlorocarbanilate; desmedipham ethyl 3-phenylcarbamoyloxyphenylcarbamate; swep methyl 3,4-dichlorocarbanilate; cyclohexene oxime herbicides such as butroxydim (RS)-(EZ)-5-(3-butyryl-2,4,6-trimethylphenyl)-2-(1-ethoxyiminopropyl)-3-hydroxycyclohex-2-en-1-one; tepraloxydim (RS)-(EZ)-2-{1-[(2E)-3-chloroallyloxyimino]propyl}-3-hydroxy-5-perhydropyran-4-ylcyclohex-2-en-1-one; cyclopropylisoxazole herbicides such as isoxachlortole 4-chloro-2-mesylphenyl 5-cyclopropyl-1,2-oxazol-4-yl ketone; dicarboximide herbicides such as flumezin 2-methyl-4-(α,α,α-trifluoro-m-tolyl)-1,2,4-oxadiazinane-3,5-dione; dinitroaniline herbicides such as ethalfluralin N-ethyl-α,α,α-trifluoro-N-(2-methylallyl)-2,6-dinitro-p-toluidine; prodiamine 5-dipropylamino-α,α,α-trifluoro-4,6-dinitro-o-toluidine; dinitrophenol herbicides such as dinoprop 4,6-dinitro-o-cymen-3-ol; etinofen α-ethoxy-4,6-dinitro-o-cresol; diphenyl ether herbicides such as ethoxyfen O-[2-chloro-5-(2-chloro-α,α,α-trifluoro-p-tolyloxy)benzoyl]-L-lactic acid; nitrophenyl ether herbicides such as aclonifen 2-chloro-6-nitro-3-phenoxyaniline; nitrofen 2,4-dichlorophenyl 4-nitrophenyl ether; dithiocarbamate herbicides such as dazomet 3,5-dimethyl-1,3,5-thiadiazinane-2-thione; halogenated aliphatic herbicides such as dalapon 2,2-dichloropropionic acid; chloroacetic acid; imidazolinone herbicides such as imazapyr (RS)-2-(4-isopropyl-4-methyl-5-oxo-2-imidazolin-2-yl)nicotinic acid; inorganic herbicides such as disodium tetraborate decahydrate; sodium azide; nitrile herbicides such as chloroxynil 3,5-dichloro-4-hydroxybenzonitrile; ioxynil 4-hydroxy-3,5-di-iodobenzonitrile; organophosphorus herbicides such as anilofos S-4-chloro-N-isopropylcarbaniloylmethyl O,O-dimethyl phosphorodithioate; glufosinate 4-[hydroxy(methyl)phosphinoyl]-DL-homoalanine; phenoxy herbicides such as clomeprop (RS)-2-(2,4-dichloro-m-tolyloxy)propionanilide; fenteracol 2-(2,4,5-trichlorophenoxy)ethanol; phenoxyacetic herbicides such as MCPA (4-chloro-2-methylphenoxy)acetic acid; phenoxybutyric herbicides such as MCPB 4-(4-chloro-o-tolyloxy)butyric acid; phenoxypropionic herbicides such as fenoprop (RS)-2-(2,4,5-trichlorophenoxy)propionic acid; aryloxyphenoxypropionic herbicides such as isoxapyrifop (RS)-2-[2-[4-(3,5-dichloro-2-pyridyloxy)phenoxy]propionyl]isoxazolidine; phenylenediamine herbicides such as dinitramine N¹,N¹-diethyl-2,6-dinitro-4-trifluoromethyl-m-phenylenediamine, pyrazolyloxyacetophenone herbicides such as pyrazoxyfen 2-[4-(2,4-dichlorobenzoyl)-1,3-dimethylpyrazol-5-yloxy]acetophenone; pyrazolylphenyl herbicides such as pyraflufen 2-chloro-5-(4-chloro-5-difluoromethoxy-1-methylpyrazol-3-yl)-4-fluorophenoxyacetic acid; pyridazine herbicides such as pyridafol 6-chloro-3-phenylpyridazin-4-ol; pyridazinone herbicides such as chloridazon 5-amino-4-chloro-2-phenylpyridazin-3(2H)-one; oxapyrazon 5-bromo-1,6-dihydro-6-oxo-1-phenylpyridazin-4-yloxamic acid; pyridine herbicides such as fluoroxypyr 4-amino-3,5-dichloro-6-fluoro-2-pyridyloxyacetic acid; thiazopyr methyl 2-difluoromethyl-5-(4,5-dihydro-1,3-thiazol-2-yl)-4-isobutyl-6-trifluoromethylnicotinate; pyrimidinediamine herbicides such as iprymidam 6-chloro-N⁴-isopropylpyrimidine-2,4-diamine; quaternary ammonium herbicides such as diethamquat 1,1′-bis(diethylcarbamoylmethyl)-4,4′-bipyridinium; paraquat 1,1′-dimethyl-4,4′-bipyridinium; thiocarbamate herbicides such as cycloate S-ethyl cyclohexyl(ethyl)thiocarbamate; tiocarbazil S-benzyl di-sec-butylthiocarbamate; thiocarbonate herbicides such as EXD O,O-diethyl dithiobis(thioformate); thiourea herbicides such as methiuron 1,1-dimethyl-3-m-tolyl-2-thiourea; triazine herbicides such as triaziflam (RS)—N-[2-(3,5-dimethylphenoxy)-1-methylethyl]-6-(1-fluoro-1-methylethyl)-1,3,5-triazine-2,4-diamine; chlorotriazine herbicides such as cyprazine 6-chloro-N²-cyclopropyl-N⁴-isopropyl-1,3,5-triazine-2,4-diamine; propazine 6-chloro-N²,N⁴-di-isopropyl-1,3,5-triazine-2,4-diamine; methoxytriazine herbicides such as prometon N²,N⁴-di-isopropyl-6-methoxy-1,3,5-triazine-2,4-diamine; methylthiotriazine herbicides such as cyanatryn 2-(4-ethylamino-6-methylthio-1,3,5-triazin-2-ylamino)-2-methylpropionitrile; triazinone herbicides such as hexazinone 3-cyclohexyl-6-dimethylamino-1-methyl-1,3,5-triazine-2,4(1H,3H)-dione; triazole herbicides such as epronaz N-ethyl-N-propyl-3-propylsulphonyl-1H-1,2,4-triazole-1-carboxamide; triazolone herbicides such as carfentrazone (RS)-2-chloro-3-{2-chloro-5-[4-(difluoromethyl)-4,5-dihydro-3-methyl-5-oxo-1H-1,2,4-triazol-1-yl]-4-fluorophenyl}propionic acid; triazolopyrimidine herbicides such as florasulam 2′,6′,8-trifluoro-5-methoxyl[1,2,4]triazolo[1,5-c]pyrimidine-2-sulphonanilide; uracil herbicides such as flupropacil isopropyl 2-chloro-5-(1,2,3,6-tetrahydro-3-methyl-2,6-dioxo-4-trifluoromethylpyrimidin-1-yl)benzoate; urea herbicides such as cycluron 3-cyclo-octyl-1,1-dimethylurea; monisouron 1-(5-tert-butyl-1,2-oxazol-3-yl)-3-methylurea; phenylurea herbicides such as chloroxuron 3-[4-(4-chlorophenoxy)phenyl]-1,1-dimethylurea; siduron 1-(2-methylcyclohexyl)-3-phenylurea; pyrimidinylsulphonylurea herbicides such as flazasulphuron 1-(4,6-dimethoxypyrimidin-2-yl-3-(3-trifluoromethyl-2-pyridylsulphonyl)urea; pyrazosulphuron 5-[(4,6-dimethoxypyrimidin-2-ylcarbamoyl)sulphamoyl]-1-methylpyrazole-4-carboxylic acid; triazinylsulphonylurea herbicides such as thifensulphuron 3-(4-methoxy-6-methyl-1,3,5-triazin-2-ylcarbamoylsulphamoyl)thiophene-2-carboxylic acid; thiadiazolylurea herbicides such as tebuthiuron 1-(5-tert-butyl-1,3,4-thiadiazol-2-yl-1,3-dimethylurea; and/or unclassified herbicides such as chlorfenac (2,3,6-trichlorophenyl)acetic acid; methazole 2-(3,4-dichlorophenyl)-4-methyl-1,2,4-oxadiazolidine-3,5-dione; tritac (RS)-1-(2,3,6-trichlorobenzyloxy)propan-2-ol; 2,4-D, chlorimuron, and fenoxaprop; and combinations thereof.

Ingredient (h3) is a pesticide. Suitable pesticides are exemplified by atrazine, diazinon, and chlorpyrifos. For purposes of this application, pesticide includes insect repellents such as N,N-diethyl-meta-toluamide and pyrethroids such as pyrethrin.

Ingredient (h4) is an antimicrobial agent. Suitable antimicrobials are commercially available, such as DOW CORNING® 5700 and DOW CORNING® 5772, which are from Dow Corning Corporation of Midland, Mich., U.S.A.

Alternatively, ingredient (H) may comprise a boron containing material, e.g., boric anhydride, borax, or disodium octaborate tetrahydrate; which may function as a pesticide, fungicide, and/or flame retardant.

### Ingredient (J) Flame Retardant

Ingredient (J) is a flame retardant. Suitable flame retardants may include, for example, carbon black, hydrated aluminum hydroxide, and silicates such as wollastonite, platinum and platinum compounds. Alternatively, the flame retardant may be selected from halogen based flame-retardants such as decabromodiphenyloxide, octabromordiphenyl oxide, hexabromocyclododecane, decabromobiphenyl oxide, diphenyoxybenzene, ethylene bis-tetrabromophthalmide, pentabromoethyl benzene, pentabromobenzyl acrylate, tribromophenyl maleic imide, tetrabromobisphenyl A, bis-(tribromophenoxy) ethane, bis-(pentabromophenoxy) ethane, polydibomophenylene oxide, tribromophenylallyl ether, bis-dibromopropyl ether, tetrabromophthalic anhydride, dibromoneopentyl gycol, dibromoethyl dibromocyclohexane, pentabromodiphenyl oxide, tribromostyrene, pentabromochlorocyclohexane, tetrabromoxylene, hexabromocyclododecane, brominated polystyrene, tetradecabromodiphenoxybenzene, trifluoropropene and PVC. Alternatively, the flame retardant may be selected from phosphorus based flame-retardants such as (2,3-dibromopropyl)-phosphate, phosphorus, cyclic phosphates, triaryl phosphate, bis-melaminium pentate, pentaerythritol bicyclic phosphate, dimethyl methyl phosphate, phosphine oxide diol, triphenyl phosphate, tris-(2-chloroethyl) phosphate, phosphate esters such as tricreyl, trixylenyl, isodecyl diphenyl, ethylhexyl diphenyl, phosphate salts of various amines such as ammonium phosphate, trioctyl, tributyl or tris-butoxyethyl phosphate ester. Other flame retardants may include tetraalkyl lead compounds such as tetraethyl lead, iron pentacarbonyl, manganese methyl cyclopentadienyl tricarbonyl, melamine and derivatives such as melamine salts, guanidine, dicyandiamide, ammonium sulphamate, alumina trihydrate, and magnesium hydroxide alumina trihydrate.

The amount of flame retardant will vary depending on factors such as the flame retardant selected and whether solvent is present. However, the amount of flame retardant in the composition may range from greater than 0% to 10% based on the combined weight of all ingredients in the composition.

### Ingredient (K) Surface Modifier

Ingredient (K) is a surface modifier. Suitable surface modifiers are exemplified by (k1) an adhesion promoter or (k2) a release agent. Suitable adhesion promoters for ingredient (k1) may comprise a transition metal chelate, a hydrocarbonoxysilane such as an alkoxysilane, a combination of an alkoxysilane and a hydroxy-functional polyorganosiloxane, an aminofunctional silane, or a combination thereof. Adhesion promoters are known in the art and may comprise silanes having the formula R²⁴ₜR²⁵ᵤSi(OR²⁶)₄₋₍ₜ₊ᵤ₎ where each R²⁴ is independently a monovalent organic group having at least 3 carbon atoms; R²⁵ contains at least one SiC bonded substituent having an adhesion-promoting group, such as amino, epoxy, mercapto or acrylate groups; subscript t has a value ranging from 0 to 2; subscript u is either 1 or 2; and the sum of (t+u) is not greater than 3. Alternatively, the adhesion promoter may comprise a partial condensate of the above silane. Alternatively, the adhesion promoter may comprise a combination of an alkoxysilane and a hydroxy-functional polyorganosiloxane.

Alternatively, the adhesion promoter may comprise an unsaturated or epoxy-functional compound. The adhesion promoter may comprise an unsaturated or epoxy-functional alkoxysilane. For example, the functional alkoxysilane can have the formula R²⁷ᵥSi(OR²⁸)₍₄₋ᵥ₎, where subscript v is 1, 2, or 3, alternatively subscript v is 1. Each R²⁷ is independently a monovalent organic group with the proviso that at least one R²⁷ is an unsaturated organic group or an epoxy-functional organic group. Epoxy-functional organic groups for R²⁷ are exemplified by 3-glycidoxypropyl and (epoxycyclohexyl)ethyl. Unsaturated organic groups for R²⁷ are exemplified by 3-methacryloyloxypropyl, 3-acryloyloxypropyl, and unsaturated monovalent hydrocarbon groups such as vinyl, allyl, hexenyl, undecylenyl. Each R²⁸ is independently a saturated hydrocarbon group of 1 to 4 carbon atoms, alternatively 1 to 2 carbon atoms. R²⁸ is exemplified by methyl, ethyl, propyl, and butyl.

Examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof.

Alternatively, the adhesion promoter may comprise an epoxy-functional siloxane such as a reaction product of a hydroxy-terminated polyorganosiloxane with an epoxy-functional alkoxysilane, as described above, or a physical blend of the hydroxy-terminated polyorganosiloxane with the epoxy-functional alkoxysilane. The adhesion promoter may comprise a combination of an epoxy-functional alkoxysilane and an epoxy-functional siloxane. For example, the adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

Alternatively, the adhesion promoter may comprise an aminofunctional silane, such as an aminofunctional alkoxysilane exemplified by H₂N(CH₂)₂Si(OCH₃)₃, H₂N(CH₂)₂Si(OCH₂CH₃)₃, H₂N(CH₂)₃Si(OCH₃)₃, H₂N(CH₂)₃Si(OCH₂CH₃)₃, CH₃NH(CH₂)₃Si(OCH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃Si(OCH₂CH₃)₃, CH₃NH(CH₂)₂NH(CH₂)₃Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₃SiCH₃(OCH₂CH₃)₂, CH₃NH(CH₂)₅SiCH₃(OCH₃)₂, CH₃NH(CH₂)₅SiCH₃(OCH₂CH₃)₂, H₂N(CH₂)₂NH(CH₂)₃SiCH₃(OCH₃)₂, H₂N(CH₂)₂NH(CH₂)₃SiCH₃(OCH₂CH₃)₂, CH₃NH(CH₂)₂NH(CH₂)₃SiCH₃(OCH₃)₂, CH₃NH(CH₂)₂NH(CH₂)₃ SiCH₃ (OCH₂CH₃)₂, C₄H₉NH(CH₂)₂NH(CH₂)₃ SiCH₃ (OCH₃)₂, C₄H₉NH(CH₂)₂NH(CH₂)₃SiCH₃(OCH₂CH₃)₂, and a combination thereof.

Alternatively, the adhesion promoter may comprise a transition metal chelate. Suitable transition metal chelates include titanates, zirconates such as zirconium acetylacetonate, aluminum chelates such as aluminum acetylacetonate, and combinations thereof.

Ingredient (k2) is a release agent. Suitable release agents are exemplified by fluorinated compounds, such as fluoro-functional silicones, or fluoro-functional organic compounds.

Alternatively, the surface modifier for ingredient (K) may be used to change the appearance of the surface of a reaction product of the composition. For example, surface modifier may be used to increase gloss of the surface of a reaction product of the composition. Such a surface modifier may comprise a polydiorganosiloxane with alkyl and aryl groups. For example, DOW CORNING® 550 Fluid is a trimethylsiloxy-terminated poly(dimethyl/methylphenyl)siloxane with a viscosity of 125 cSt that is commercially available from Dow Corning Corporation.

Alternatively, ingredient (K) may be a natural oil obtained from a plant or animal source, such as linseed oil, tung oil, soybean oil, castor oil, fish oil, hempseed oil, cottonseed oil, oiticica oil, and rapeseed oil.

The exact amount of ingredient (K) depends on various factors including the type of surface modifier selected as ingredient (K) and the end use of the composition and its reaction product. However, ingredient (K), when present, may be added to the composition in an amount ranging from 0.01 to 50 weight parts based on the weight of the composition, alternatively 0.01 to 10 weight parts, and alternatively 0.01 to 5 weight parts. Ingredient (K) may be one adhesion promoter. Alternatively, ingredient (K) may comprise two or more different surface modifiers that differ in at least one of the following properties: structure, viscosity, average molecular weight, polymer units, and sequence.

### Ingredient (L) Chain Lengthener

Chain lengtheners may include difunctional silanes and difunctional siloxanes, which extend the length of polyorganosiloxane chains before crosslinking occurs. Chain lengtheners may be used to reduce the modulus of elongation of the cured product. Chain lengtheners and crosslinkers compete in their reactions with the hydrolyzable substituents in ingredient (B). To achieve noticeable chain extension, the difunctional silane has substantially higher reactivity than the trifunctional crosslinker with which it is used. Suitable chain lengtheners include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethyldimethoxysilane, dimethyldiethoxysilane and α-aminoalkyldialkoxyalkylsilanes, polydialkylsiloxanes having a degree of polymerization of from 2 to 25 and having an average per molecule of at least two hydrolyzable groups, such as acetamido or acetoxy or amino or alkoxy or amido or ketoximo substituents, and diketoximinosilanes such as dialkylkdiketoximinosilanes and alkylalkenyldiketoximinosilanes. Ingredient (L) may be one chain lengthener. Alternatively, ingredient (L) may comprise two or more different chain lengtheners that differ in at least one of the following properties: structure, viscosity, average molecular weight, polymer units, and sequence

### Ingredient (M) Endblocker

Ingredient (M) is and endblocker comprising an M unit, i.e., a siloxane unit of formula R²⁹₃SiO½, where each R²⁹ independently represents a monovalent organic group unreactive ingredient (B), such as a monovalent hydrocarbon group. Ingredient (M) may comprise polyorganosiloxanes endblocked on one terminal end by a triorganosilyl group, e.g., (CH₃)₃SiO—, and on the other end by a hydroxyl group. Ingredient (M) may be a polydiorganosiloxane such as a polydimethylsiloxane. The polydiorganosiloxanes having both hydroxyl end groups and triorganosilyl end groups, may have more than 50%, alternatively more than 75%, of the total end groups as hydroxyl groups. The amount of triorganosilyl group in the polydimethylsiloxane may be used to regulate the modulus of the reaction product prepared by condensation reaction of the composition. Without wishing to be bound by theory, it is thought that higher concentrations of triorganosilyl end groups may provide a lower modulus in certain cured products. Ingredient (M) may be one endblocker. Alternatively, ingredient (M) may comprise two or more different endblockers that differ in at least one of the following properties: structure, viscosity, average molecular weight, polymer units, and sequence.

### Ingredient (N) Non-Reactive Binder

Ingredient (N) is a non-reactive, elastomeric, organic polymer, i.e., an elastomeric organic polymer that does not react with ingredient (B). Ingredient (N) is compatible with ingredient (B), i.e., ingredient (N) does not form a two-phase system with ingredient (B). Ingredient (N) may have low gas and moisture permeability. Ingredient (N) may have Mn ranging from 30,000 to 75,000. Alternatively, ingredient (N) may be a blend of a higher molecular weight, non-reactive, elastomeric, organic polymer with a lower molecular weight, non-reactive, elastomeric, organic polymer. In this case, the higher molecular weight polymer may have Mn ranging from 100,000 to 600,000 and the lower molecular weight polymer may have Mn ranging from 900 to 10,000, alternatively 900 to 3,000. The value for the lower end of the range for Mn may be selected such that ingredient (N) has compatibility with ingredient (B) and the other ingredients of the composition.

Ingredient (N) may comprise a polyisobutylene. Polyisobutylenes are known in the art and are commercially available. Examples suitable for use as ingredient (N) include polyisobutylenes marketed under the trademark OPPANOL® by BASF Corporation of Germany. Such polyisobutylenes are summarized in the table below.

| | | | | | Viscosity |
|---|---|---|---|---|---|
| OPPANOL ® | Mw | Mw/Mn | Mn | Mv | (@150 C.) |
| B10 | 36,000 | 3 | 12,000 | 40,000 | 40,000 |
| B11 | 46,000 | 3.2 | 14,375 | 49,000 | 100,000 |
| B12 | 51,000 | 3.2 | 15,938 | 55,000 | 150,000 |
| B13 | 60,000 | 3.2 | 18,750 | 65,000 | 250,000 |
| B14 | 65,000 | 3.3 | 19,697 | 73,000 | 450,000 |
| B15 | 75,000 | 3.4 | 22,059 | 85,000 | 750,000 |
| B30 | | | 73,000 | 200,000 | |
| B50 | | | 120,000 | 400,000 | |
| B80 | | | 200,000 | 800,000 | |
| B100 | | | 250,000 | 1,100,000 | |
| B150 | | | 425,000 | 2,600,000 | |
| B200 | | | 600,000 | 4,000,000 | |

Other polyisobutylenes include different Parleam grades such as highest molecular weight hydrogenated polyisobutene PARLEAM® SV (POLYSYNLANE SV) from NOF CORPORATION Functional Chemicals & Polymers Div., Yebisu Garden Place Tower, 20-3 Ebisu 4-chome, Shibuya-ku, Tokyo 150-6019, Japan (Kinematic Viscosity (98.9° C.) 4700). Other polyisobutylenes are commercially available from ExxonMobil Chemical Co. of Baytown, Tex., U.S.A. and include polyisobutylenes marketed under the trademark VISTANEX®, such as MML-80, MML-100, MML-120, and MML-140. VISTANEX® polyisobutylenes are paraffinic hydrocarbon polymers, composed of long, straight-chain macromolecules containing only chain-end olefinic bonds. VISTANEX® MM polyisobutylenes have viscosity average molecular weight ranging from 70,000 to 90,000. Lower molecular weight polyisobutylenes include VISTANEX® LM, such as LM-MS (viscosity average molecular weight ranging from 8,700 to 10,000 also made by ExxonMobil Chemical Co.) and VISTANEX LM-MH (viscosity average molecular weight of 10,000 to 11,700) as well as Soltex PB-24 (Mn 950) and Indopol® H-100 (Mn 910) and Indopol® H-1200 (Mn 2100) from Amoco. Other polyisobutylenes are marketed under the trademarks NAPVIS® and HYVIS® by BP Chemicals of London, England. These polyisobutylenes include NAPVIS® 200, D10, and DE3; and HYVIS® 200. The NAPVIS® polyisobutylenes may have Mn ranging from 900 to 1300.

Alternatively, ingredient (N) may comprise butyl rubber. Alternatively, ingredient (N) may comprise a styrene-ethylene/butylene-styrene (SEBS) block copolymer, a styrene-ethylene/propylene-styrene (SEPS) block copolymer, or a combination thereof. SEBS and SEPS block copolymers are known in the art and are commercially available as Kraton® G polymers from Kraton Polymers U.S. LLC of Houston, Tex., U.S.A., and as Septon polymers from Kuraray America, Inc., New York, N.Y., U.S.A. Alternatively, ingredient (N) may comprise a polyolefin plastomer. Polyolefin plastomers are known in the art and are commercially available as AFFINITY® GA 1900 and AFFINITY® GA 1950 from Dow Chemical Company, Elastomers & Specialty Products Division, Midland, Mich., U.S.A.

The amount of ingredient (N) may range from 0 parts to 50 parts, alternatively 10 parts to 40 parts, and alternatively 5 parts to 35 parts, based on the weight of the composition. Ingredient (N) may be one non-reactive, elastomeric, organic polymer. Alternatively, ingredient (N) may comprise two or more non-reactive, elastomeric, organic polymers that differ in at least one of the following properties: structure, viscosity, average molecular weight, polymer units, and sequence. Alternatively, ingredient (N) may be added to the composition when ingredient (B) comprises a base polymer with an organic polymer backbone.

### Ingredient (O) Anti-Aging Additive

Ingredient (O) is an anti-aging additive. The anti-aging additive may comprise an antioxidant, a UV absorber, a UV stabilizer, a heat stabilizer, or a combination thereof. Suitable antioxidants are known in the art and are commercially available. Suitable antioxidants include phenolic antioxidants and combinations of phenolic antioxidants with stabilizers. Phenolic antioxidants include fully sterically hindered phenols and partially hindered phenols. Alternatively, the stabilizer may be a sterically hindered amine such as tetramethyl-piperidine derivatives. Suitable phenolic antioxidants include vitamin E and IRGANOX® 1010 from Ciba Specialty Chemicals, U.S.A. IRGANOX® 1010 comprises pentaerythritol tetrakis(3-(3,5-di-t-butyl-4-hydroxyphenyl)propionate). Examples of UV absorbers include phenol, 2-(2H-benzotriazol-2-yl)-6-dodecyl-4-methyl-, branched and linear (TINUVIN® 571). Examples of UV stabilizers include bis(1,2,2,6,6-pentamethyl-4-piperidyl)sebacate; methyl 1,2,2,6,6-pentamethyl-4-piperidyl/sebacate; and a combination thereof (TINUVIN® 272). These and other TINUVIN® additives, such as TINUVIN® 765 are commercially available from Ciba Specialty Chemicals of Tarrytown, N.Y., U.S.A. Other UV and light stabilizers are commercially available, and are exemplified by LowLite from Chemtura, OnCap from PolyOne, and Light Stabilizer 210 from E. I. du Pont de Nemours and Company of Delaware, U.S.A. Oligomeric (higher molecular weight) stabilizers may alternatively be used, for example, to minimize potential for migration of the stabilizer out of the composition or the cured product thereof. An example of an oligomeric antioxidant stabilizer (specifically, hindered amine light stabilizer (HALS)) is Ciba TINUVIN® 622, which is a dimethylester of butanedioic acid copolymerized with 4-hydroxy-2,2,6,6-tetramethyl-1-piperidine ethanol. Heat stabilizers may include iron oxides and carbon blacks, iron carboxylate salts, cerium hydrate, barium zirconate, cerium and zirconium octoates, and porphyrins.

The amount of ingredient (O) depends on various factors including the specific anti-aging additive selected and the anti-aging benefit desired. However, the amount of ingredient (O) may range from 0 to 5 weight %, alternatively 0.1% to 4%, and alternatively 0.5% to 3%, based on the weight of the composition. Ingredient (O) may be one anti-aging additive. Alternatively, ingredient (O) may comprise two or more different anti-aging additives.

### Ingredient (P) Water Release Agent

Ingredient (P) is a water release agent that releases water over an application temperature range. Ingredient (P) is selected such that ingredient (P) contains an amount of water sufficient to partially or fully react the composition and such that ingredient (P) releases the sufficient amount of water when exposed for a sufficient amount of time to a use temperature (i.e., a temperature at which the composition is used). However, ingredient (P) binds the water sufficiently to prevent too much water from being released during the method for making the composition and during storage of the composition. For example, ingredient (P) binds the water sufficiently during compounding of the composition such that sufficient water is available for condensation reaction of the composition during or after the application process in which the composition is used. This “controlled release” property also may provide the benefit of ensuring that not too much water is released too rapidly during the application process, since this may cause bubbling or voiding in the reaction product formed by condensation reaction of the composition. Precipitated calcium carbonate may be used as ingredient (P) when the application temperature ranges from 80° C. to 120° C., alternatively 90° C. to 110° C., and alternatively 90° C. to 100° C. However, when the composition is prepared on a continuous (e.g., twin-screw) compounder, the ingredients may be compounded at a temperature 20° C. to 30° C. above the application temperature range for a short amount of time. Therefore, ingredient (P) is selected to ensure that not all of the water content is released during compounding, however ingredient (P) releases a sufficient amount of water for condensation reaction of the composition when exposed to the application temperature range for a sufficient period of time.

Examples of suitable water release agents are exemplified by metal salt hydrates, hydrated molecular sieves, and precipitated calcium carbonate, which is available from Solvay under the trademark WINNOFIL® SPM. The water release agent selected will depend on various factors including the other ingredients selected for the composition, including catalyst type and amount; and the process conditions during compounding, packaging, and application. In a twin-screw compounder, residence time may be less than a few minutes, typically less than 1 to 2 minutes. The ingredients are heated rapidly because the surface area/volume ratio in the barrels and along the screw is high and heat is induced by shearing the ingredients. How much water is removed from ingredient (P) depends on the water binding capabilities, the temperature, the exposure time (duration), and the level of vacuum used to strip the composition passing through the compounder. Without wishing to be bound by theory, it is thought that with a twin screw compounding temperature of 120° C. there will remain enough water on the precipitated CaCO₃ to cause the composition to react by condensation reaction over a period of 1 to 2 weeks at room temperature when the composition has been applied at 90° C.

A water release agent may be added to the composition, for example, when the base polymer has low water permeability (e.g., when the base polymer has an organic polymer backbone) and/or the amount of ingredient (P) in the composition depends on various factors including the selection of ingredients (A), (B) and (C) and whether any additional ingredients are present, however the amount of ingredient (P) may range from 5 to 30 parts based on the weight of the composition.

Without wishing to be bound by theory, it is thought when the composition is heated to the application temperature, the heat will liberate the water, the water will react with the hydrolyzable groups on ingredient (B) to cure the composition. By-products such as alcohols and/or water left in the composition may be bound by a drying agent, thereby allowing the condensation reaction (which is an equilibrium reaction) to proceed toward completion.

### Ingredient (Q) Pigment

Ingredient (Q) is a pigment. For purposes of this application, the term ‘pigment’ includes any ingredient used to impart color to a reaction product of a composition described herein. The amount of pigment depends on various factors including the type of pigment selected and the desired degree of coloration of the reaction product. For example, the composition may comprise 0 to 20%, alternatively 0.001% to 5%, of a pigment based on the weight of all ingredients in the composition.

Examples of suitable pigments include indigo, titanium dioxide Stan-Tone 5051′01 Green (which is commercially available from PolyOne) and carbon black. Representative, non-limiting examples of carbon black include Shawinigan Acetylene black, which is commercially available from Chevron Phillips Chemical Company LP; SUPERJET® Carbon Black (LB-1011) supplied by Elementis Pigments Inc., of Fairview Heights, Ill. U.S.A.; SR 511 supplied by Sid Richardson Carbon Co, of Akron, Ohio U.S.A.; and N330, N550, N762, N990 (from Degussa Engineered Carbons of Parsippany, N.J., U.S.A.).

### Ingredient (R) Rheological Additive

The composition may optionally further comprise up to 5%, alternatively 1% to 2% based on the weight of the composition of ingredient (R) a rheological additive for modifying rheology of the composition. Rheological additives are known in the art and are commercially available. Examples include polyamides, Polyvest, which is commercially available from Evonk, Disparlon from King Industries, Kevlar Fibre Pulp from Du Pont, Rheospan from Nanocor, and Ircogel from Lubrizol. Other suitable rheological additives include polyamide waxes; hydrogenated castor oil derivatives; and metal soaps such as calcium stearate, aluminum stearate and barium stearate, and combinations thereof.

Alternatively, ingredient (R) may comprise a microcrystalline wax that is a solid at 25° C. (wax). The melting point may be selected such that the wax has a melting point at the low end of the desired application temperature range. Without wishing to be bound by theory, it is thought that ingredient (R) acts as a process aid that improves flow properties while allowing rapid green strength development (i.e., a strong increase in viscosity, corresponding to increase in the load carrying capability of a seal prepared from the composition, with a temperature drop) upon cooling the composition a few degrees, for example, after the composition is applied to a substrate. Without wishing to be bound by theory, it is thought that incorporation of wax may also facilitate incorporation of fillers, compounding and de-airing (during production of the composition), and mixing (static or dynamic mixing during application of parts of a multiple-part composition). It is thought that the wax, when molten, serves as a process aid, substantially easing the incorporation of filler in the composition during compounding, the compounding process itself, as well as in during a de-airing step, if used. The wax, with a melt temperature below 100° C., may facilitate mixing of the parts of a multiple part composition before application, even in a simple static mixer. The wax may also facilitate application of the composition at temperatures ranging from 80° C. to 110° C., alternatively 90° C. to 100° C. with good rheology.

Waxes suitable for use as ingredient (R) may be non-polar hydrocarbons. The waxes may have branched structures, cyclic structures, or combinations thereof. For example, petroleum microcrystalline waxes are available from Strahl & Pitsch, Inc., of West Babylon, N.Y., U.S.A. and include SP 96 (melting point ranging from 62° C. to 69° C.), SP 18 (melting point ranging from 73° C. to 80° C.), SP 19 (melting point ranging from 76° C. to 83° C.), SP 26 (melting point ranging from 76° C. to 83° C.), SP 60 (melting point ranging from 79° C. to 85° C.), SP 617 (melting point ranging from 88° C. to 93° C.), SP 89 (melting point ranging from 90° C. to 95° C.), and SP 624 (melting point ranging from 90° C. to 95° C.). Other petroleum microcrystalline waxes include waxes marketed under the trademark Multiwax® by Crompton Corporation of Petrolia, Pa., U.S.A. These waxes include 180-W, which comprises saturated branched and cyclic non-polar hydrocarbons and has melting point ranging from 79° C. to 87° C.; Multiwax® W-445, which comprises saturated branched and cyclic non-polar hydrocarbons, and has melting point ranging from 76° C. to 83° C.; and Multiwax® W-835, which comprises saturated branched and cyclic non-polar hydrocarbons, and has melting point ranging from 73° C. to 80° C.

The amount of ingredient (R) depends on various factors including the specific rheological additive selected and the selections of the other ingredients of the composition. However, the amount of ingredient (R) may range from 0 parts to 20 parts, alternatively 1 parts to 15 parts, and alternatively 1 part to 5 parts based on the weight of the composition. Ingredient (R) may be one rheological additive. Alternatively, ingredient (R) may comprise two or more different rheological additives.

### Ingredient (S) Solvent

Solvent may be used in the composition. Solvent may facilitate flow of the composition and introduction of certain ingredients, such as silicone resin. Solvents used herein are those that help fluidize the ingredients of the composition but essentially do not react with any of these ingredients. Solvent may be selected based on solubility the ingredients in the composition and volatility. The solubility refers to the solvent being sufficient to dissolve and/or disperse ingredients of the composition. Volatility refers to vapor pressure of the solvent. If the solvent is too volatile (having too high vapor pressure) bubbles may form in the composition at the application temperature, and the bubbles may cause cracks or otherwise weaken or detrimentally affect properties of the cured product. However, if the solvent is not volatile enough (too low vapor pressure) the solvent may remain as a plasticizer in the reaction product of the composition, or the amount of time for the reaction product to develop physical properties may be longer than desired.

Suitable solvents include polyorganosiloxanes with suitable vapor pressures, such as hexamethyldisiloxane, octamethyltrisiloxane, hexamethylcyclotrisiloxane and other low molecular weight polyorganosiloxanes, such as 0.5 to 1.5 centiStoke (cSt) Dow Corning® 200 Fluids and DOW CORNING® OS FLUIDS, which are commercially available from Dow Corning Corporation of Midland, Mich., U.S.A.

Alternatively, the solvent may be an organic solvent. The organic solvent can be an alcohol such as methanol, ethanol, isopropanol, butanol, or n-propanol; a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride; chloroform; dimethyl sulfoxide; dimethyl formamide, acetonitrile; tetrahydrofuran; white spirits; mineral spirits; naphtha; n-methylpyrrolidone; or a combination thereof.

The amount of solvent will depend on various factors including the type of solvent selected and the amount and type of other ingredients selected for the composition. However, the amount of solvent may range from 1% to 99%, alternatively 2% to 50%, based on the weight of the composition.

### Ingredient (T) Tackifying Agent

The composition may optionally further comprise ingredient (T) a tackifying agent. The tackifying agent may comprise an aliphatic hydrocarbon resin such as a hydrogenated polyolefin having 6 to 20 carbon atoms, a hydrogenated terpene resin, a rosin ester, a hydrogenated rosin glycerol ester, or a combination thereof. Tackifying agents are commercially available. Aliphatic hydrocarbon resins are exemplified by ESCOREZ 1102, 1304, 1310, 1315, and 5600 from Exxon Chemical and Eastotac resins from Eastman, such as Eastotac H-100 having a ring and ball softening point of 100° C., Eastotac H-115E having a ring and ball softening point of 115° C., and Eastotac H-130L having a ring and ball softening point of 130° C. Hydrogenated terpene resins are exemplified by Arkon P 100 from Arakawa Chemicals and Wingtack 95 from Goodyear. Hydrogenated rosin glycerol esters are exemplified by Staybelite Ester 10 and Foral from Hercules. Examples of commercially available polyterpenes include Piccolyte A125 from Hercules. Examples of aliphatic/aromatic or cycloaliphatic/aromatic resins include ECR 149B or ECR 179A from Exxon Chemical. Alternatively, a solid tackifying agent (i.e., a tackifying agent having a ring and ball softening point above 25° C.), may be added. Suitable tackifying agents include any compatible resins or mixtures thereof such as (1) natural or modified rosins such, for example, as gum rosin, wood rosin, tall-oil rosin, distilled rosin, hydrogenated rosin, dimerized rosin, and polymerized rosin; (2) glycerol and pentaerythritol esters of natural or modified rosins, such, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natural terpenes, e.g., styrene/terpene and alpha methyl styrene/terpene; (4) polyterpene resins having a softening point, as determined by ASTM method E28,58T, ranging from 60° C. to 150° C.; the latter polyterpene resins generally resulting from the polymerization of terpene hydrocarbons, such as the bicyclic monoterpene known as pinene, in the presence of Friedel-Crafts catalysts at moderately low temperatures; also included are the hydrogenated polyterpene resins; (5) phenolic modified terpene resins and hydrogenated derivatives thereof, for example, as the resin product resulting from the condensation, in an acidic medium, of a bicyclic terpene and phenol; (6) aliphatic petroleum hydrocarbon resins having a ring and ball softening point ranging from 60° C. to 135° C.; the latter resins resulting from the polymerization of monomers consisting of primarily of olefins and diolefins; also included are the hydrogenated aliphatic petroleum hydrocarbon resins; (7) alicyclic petroleum hydrocarbon resins and the hydrogenated derivatives thereof; and (8) aliphatic/aromatic or cycloaliphatic/aromatic copolymers and their hydrogenated derivatives. The amount of tackifying agent depends on various factors including the specific tackifying agent selected and the selection the other ingredients in the composition. However, the amount of tackifying agent may range from 0 parts to 20 parts based on the weight of the composition.

One skilled in the art would recognize when selecting ingredients for the composition described above, there may be overlap between types of ingredients because certain ingredients described herein may have more than one function. For example, certain alkoxysilanes may be useful as filler treating agents and as adhesion promoters, certain fatty acid esters may be useful as plasticizers and may also be useful as filler treating agents, carbon black may be useful as a pigment, a flame retardant, and/or a filler, and nonreactive polydiorganosiloxanes such as polydimethylsiloxanes may be useful as extenders and as solvents. One skilled in the art would be able to distinguish among and select appropriate ingredients, and amounts thereof, based on various factors including the intended use of the composition, the form and intended use of the cured product of the composition, and whether the composition will be prepared as a one-part or multiple-part composition. One skilled in the art would be able to select ingredients, and amounts thereof, to prepare a composition such that the reaction product of the composition has a desired form, such as a gum, a gel, or a rubber.

### Method of Making the Composition

The composition described above may be prepared as a one part composition, for example, by combining all ingredients by any convenient means, such as mixing. For example, a one-part composition may be made by optionally combining (e.g., premixing) the base polymer (B) and an extender (E) and mixing the resulting extended base polymer with all or part of the filler (F), and mixing this with a pre-mix comprising the crosslinker (C) and ingredient (A). Other additives such as (O) the anti-aging additive and (Q) the pigment may be added to the mixture at any desired stage. A final mixing step may be performed under substantially anhydrous conditions, and the resulting compositions are generally stored under substantially anhydrous conditions, for example in sealed containers, until ready for use.

Alternatively, the composition may be prepared as a multiple part (e.g., 2 part) composition when a crosslinker is present. In this instance the catalyst and crosslinker are stored in separate parts, and the parts are combined shortly before use of the composition. For example, a two part curable composition may be prepared by combining ingredients comprising (B) and (C) to form a first (curing agent) part by any convenient means such as mixing. A second (base) part may be prepared by combining ingredients comprising (A) and (B) by any convenient means such as mixing. The ingredients may be combined at ambient or elevated temperature and under ambient or anhydrous conditions, depending on various factors including whether a one part or multiple part composition is selected. The base part and curing agent part may be combined by any convenient means, such as mixing, shortly before use. The base part and curing agent part may be combined in relative amounts of base: curing agent ranging from 1:1 to 10:1.

The equipment used for mixing the ingredients is not specifically restricted. Examples of suitable mixing equipment may be selected by one of ordinary skill in the art depending on the type and amount of each ingredient selected. For example, agitated batch kettles may be used for relatively low viscosity compositions, such as compositions that will react to form gums or gels. Alternatively, continuous compounding equipment, e.g., extruders such as twin screw extruders, may be used for more viscous compositions and compositions containing relatively high amounts of particulates. One skilled in the art would be able to prepare a composition without undue experimentation based on the description provided herein. Exemplary methods that can be used to the compositions described herein include those disclosed in, for example, U.S. Patent Publications US 2009/0291238 and US 2008/0300358.

These compositions made as described above may be stable when the stored in containers that protect the compositions from exposure to moisture, but these compositions may react via condensation reaction when exposed to atmospheric moisture. Alternatively, when a low permeability composition is formulated, the composition may cure to form a cured product when moisture is released from a water release agent.

### Methods of Use

Compositions prepared as described above, and the reaction products thereof, have various uses. The ingredients described above may be used to prepare various types of composition comprising ingredients (A) and (B). The composition may further comprise one or more of the additional ingredients described above, depending on the type of composition and the desired end use of the composition and/or the reaction product of the composition. For example, the ingredients and methods described above may be used for chain extension processes to increase viscosity of the base polymer and/or form a gum, for example, when the base polymer has an average of one to two hydrolyzable groups per molecule. Alternatively, the ingredients and methods described above may be used to formulate curable compositions, for example, when the base polymer has two or more hydrolyzable groups per molecule and/or a crosslinker is present in the composition. The compositions described herein may be reacted by condensation reaction by exposure to moisture. For example, the compositions may react via condensation reaction when exposed to atmospheric moisture. Alternatively, the composition react moisture is released from a water release agent, when a water release agent is present.

### EXAMPLES

The following examples are included to demonstrate the invention to one of ordinary skill. However, those of ordinary skill in the art should, in light of the present disclosure, appreciate that many changes can be made in the specific embodiments which are disclosed and still obtain a like or similar result without departing from the spirit and scope of the invention set forth in the claims.

### Reference Example 1

### Skin Over Time (SOT) Test

The skin-over-time, a measure of cure rate, is defined as the time in minutes required for curing material to form a non-tacky surface film by finger tip contact. Skin-over time represents the time within an end-user can tool a sealant joint.

### Reference Example 2

### Tack Free Time (TFT) Test

The tack free time, a measure of cure rate, was defined as the time in minutes required for a curing composition to form a non-tacky surface film by polyethylene contact. This method used polyethylene film contact to determine the non-tacky characteristics of a sealant. Tack-free time reflects the time needed for the surface of a product prepared by curing a composition to no longer pick-up dirt.

The test panels were prepared as described below and touched with a gloved finger (disposable nitrile gloves)—the glove should be pulled toward the skin. When the finger was released from the panel, an assessment of the test panels' (Q-panel) stickiness or tackiness was made. If no stickiness or tackiness was observed then the composition on the panel had cured, and the time taken from drawdown to tack free stage was recorded as the samples ‘tack free time’. Test panels that exhibited no cure after 4 days, are labeled ‘No Cure’. Any cure time beyond 4 days was not recorded. The appearance of the test panel was also recorded, as well as the appearance and viscosity of the sample within the jar beyond two days. This data illustrates the compatibility and pot life of the samples and records any separation of materials, gelling, or discoloration.

The following ingredients were used in the examples below.

Ingredient (B1) was a silanol terminated polydimethylsiloxane having a viscosity of 4000 cSt.

Ingredient (B2) was a methylmethoxysiloxane with methylsilsesquioxane resin having a DP of 15 and a Mw of 1,200, which was commercially available as DOW CORNING® US-CF 2403 Resin from Dow Corning Corporation of Midland, Mich., U.S.A.

Ingredient (B3) was a silanol terminated polydimethylsiloxane having a viscosity of 41 cSt.

Ingredient (C1) was methyltrimethoxysilane (MTM).

Ingredient (C2) was methyltriacetoxysilane (MTA).

Ingredient (C3) was methylethylketoxime silane (MTO).

Ingredient (C4) was a mixture of 50% ethyltriacetoxysilane, 47% methyltriacetoxysilane, and 2% of oligomers of methyl-ethyl-acetoxysilane.

Catalysts screened for ingredient (A) are in the table below. TNBT refers to tetra-n-butyl titanate. TNBT and DBTDL were used as positive controls to prepare comparative examples.

| Type | | Catalyst | Chemical Description | Supplier |
|---|---|---|---|---|
| Titanate | A1 | TNBT | Tetra-n-butyl titanate | Dupont |
| Tin | A2 | DBTDL | Dibutyl tin dilaurate | Sigma- |
| | | | | Aldrich |
| Phosphorus containing | A3 | Nacure 4054 | Alkyl acid phosphate in isobutanol 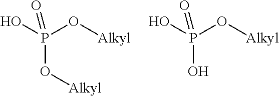 | King Industries |
| | A4 | Nacure XC-9207 | A lower molecular weight version of Nacure 4054, but a higher molecular | King |
| | | | weight than Nacure XC-C207 | Industries |
| | A5 | Nacure XC-C207 | Alkyl acid phosphate (lower molecular weight than 4054 | King |
| | | | | Industries |
| | A6 | Nacure XC-206 | A higher molecular weight than Nacure 4054 | King |
| | | | | Industries |
| | A7 | Dow Corning 4-6085 | Equilibrium mixture comprising bis(trimethylsilyl) octyl phosphonate, trimethylsilyl octylphosphonate, and octyl phosphonic acid 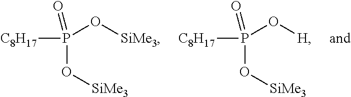 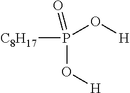 | Dow Corning Corporation |
| | A8 | Nacure XP-297 | Acid phosphate 25% in water + IPA | King |
| | | | | Industries |
| | A9 | Phosphonitrile chloride | 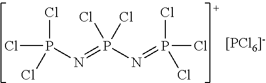 | |
| | A10 | Phospholan PE65 | Alkyl phosphate ester or alkyl acid phosphate of unknown alkyl structure | Akzo Nobel |
| | A11 | Phospholan PE169 | Mono-and di-phosphate esters based on alcohol ethoxylate in acid form 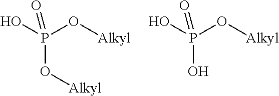 Alkyl═Ethyl | Akzo Nobel |
| | A12 | Dibutyl Phosphate | (BuO)₂PO(OH) 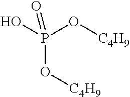 | Sigma- Aldrich |
| | A13 | Tributyl Phosphate | (BuO)3PO 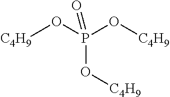 | Sigma- Aldrich |
| | A14 | Tris(trimethylsilyl)phosphate | (Me3SiO)3PO 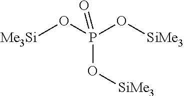 [SMILES: C[Si](C)(C)OP(=O)(O[Si](C)(C)C)O[Si](C)(C)C] | Sigma- Aldrich |
| | A15 | Tributylmethylammonium dibutyl phosphate | [(BuO)2POO]—[NBu3Me] 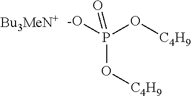 | Sigma- Aldrich |
| | A16 | Nacure XP-333 | Aromatic acid phosphate (weak acid catalyst) 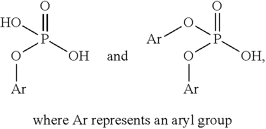 | King Industries |
| | A17 | Mono-n-dodecylphosphate | 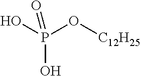 | Sigma Aldrich |
| | A18 | Bis ethyl hexyl phosphate | 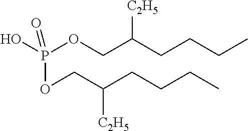 [SMILES: CCCCC(CC)COP(=O)(O)OCC(CC)CCCC] | Aldrich |
| Sulfonic | A19 | DDBSA | Dodecylbenzene Sulfonic Acid | Stepan |
| acids | A20 | K-Cure 1040 | para-Toluene sulfonic acid 40% in IPA | King |
| | | | | Industries |
| | A21 | K-cure 129B | Mixed alkyl and aryl sulfonic acids 50% in mixture of alcohols | King |
| | | | (methanol/butanol) | Industries |
| | A22 | Nacure 1059 | Hydrophobic acid catalyst based on dinonyl naphthalene sulfonic acid 50% in | King |
| | | | Aromatic 150 | Industries |
| | A23 | Nacure 155 | Hydrophobic acid catalyst based on dinonyl naphthalene disulfonic acid 55% | King |
| | | | in isobutanol | Industries |
| | A24 | Nacure XC-178 | high active content, covalently blocked catalyst based on proprietary | King |
| | | | hydrophobic acid in aromatic 100 | Industries |
| | A25 | Nacure XC-C210 | Hydrophobic sulfonic acid | King |
| | | | | Industries |
| | A26 | Nacure XC-207 | A solventlcss version of Nacure XC-C210 with a lower viscosity | King |
| | | | | Industries |

### Reference Example 3

### Sample preparation Method—Sealant Model

A catalyst, a crosslinker, and a base polymer were compounded together using the following method. A 100 ml glass jar was used to mix all materials and provide safe storage for all samples. A base polymer was added in an amount of 25 g to the jar followed by the crosslinker in an amount of 1.8 g or 0.5 g. Once the crosslinker was added, the contents of the jar were mixed thoroughly by hand using a spatula for 30 seconds. The catalyst was added to the jar and thoroughly mixed into the sample for 30 seconds or until the catalyst was uniformly mixed as much as possible.

After all ingredients were incorporated, the sample was left undisturbed for 30 minutes to allow equal opportunities of end capping, if any, to occur. Steel test plates, also called ‘Q Panels’ were used for ‘drawdowns’. These plates were rubbed with a small amount of acetone and a rag to remove any particles or dirt so as to create equal conditions of all test plates.

After the sample sat for 30 minutes, and the Q panels were free from acetone. drawdown of the sample was performed by adding a composition to the Q panel and passing a drawdown bar across the panel over the composition to form an even coating of the composition on the Q panel. The drawdown was performed using a 100 μm gap from the drawdown bar. Tack free time was measured according to the method of Reference Example 2.

### Reference Example 4

### Sample Preparation Method—Coatings Model

A catalyst was added to 10 g of a resinous base polymer in a 14 ml glass snap top vial. The amount of catalyst was 0.1 g. The top was fastened, and the vial was shaken vigorously until mixed. The resulting solution was left undisturbed for 30 minutes, at which point a drawdown of the sample was performed as described in Reference Example 3.

### Example 1

### Alkoxy Composition

Samples were prepared according to the method of Reference Example 3 using Ingredient (B1) a silanol terminated polydimethylsiloxane having a viscosity of 4000 cSt as the base polymer and 1.8 g of ingredient (C1) methyltrimethoxysilane as the crosslinker. The catalysts shown below in the table were added as ingredient (A) in amounts of 0.1%, 1.0%, and 5.0%.

### Example 1

| | | Appearance of the drawdown |
|---|---|---|
| Catalyst-Loading (%) | TFT | film |
| None (negative control) | No Cure | No Change. |
| TNBT-0.1% (control) | 4 days | smooth, clear, glossy. |
| TNBT-1% (control) | <20 hours | smooth, clear, glossy, rubbery |
| TNBT-5% (control) | 3.5 hours | smooth, clear, glossy, rubbery |
| Nacure 4054-0.1% | 23 hours | smooth, clear, glossy, slightly |
| | | greasy. |
| Nacure 4054-1% | 3 hours | smooth, clear, glossy. |
| Nacure 4054-5% | 20 min | smooth, slight haze, glossy. |
| Nacure XC-9207-0.1% | No Cure | sticky and wet. |
| Nacure XC-9207-1% | 2 hours 45 min | smooth, slight haze, glossy. |
| Nacure XC-9207-5% | 30 min | smooth, slightly haze, glossy |
| Nacure XC-C207-0.1% | No Cure | clear, sticky. |
| Nacure XC-C207-1% | No Cure | slight haze, slightly sticky. |
| Nacure XC-C207-5% | <20 hours | smooth, hazy, glossy. |
| Nacure XC-206-0.1% | No Cure | wet, and greasy. |
| Nacure XC-206-1% | <20 hours | smooth, clear, glossy. |
| Nacure XC-206-5% | 30 min | smooth, slight haze, glossy. |
| DOW CORNING ® 4-6085-0.1% | No Cure | wet, and greasy. |
| DOW CORNING ® 4-6085-1% | 28 hours | smooth, clear, glossy. |
| DOW CORNING ® 4-6085-5% | 2 hours | smooth, hazy, slightly glossy. |
| Nacure XP-297-0.1% | No Cure | wet, and greasy. |
| Nacure XP-297-1% | 48 hours | smooth, clear, glossy. |
| Nacure XP-297-5% | 27.5 hours | smooth, clear, glossy. |
| Phosphonitrile chloride-0.1% | No Cure | wet, brown staining. |
| Phosphonitrile chloride-1% | 25 min | bobbly/rippley, brown staining, |
| | | slight gloss |
| Phosphonitrile chloride-5% | 5 min | bobbly/rippley, deeper brown, |
| | | slight gloss |
| Phospholan PE65-0.1% | No Cure | wet, and greasy. |
| Phospholan PE65-1% | No Cure | forms a rubbery layer but is |
| | | still sticky on its surface. |
| Phospholan PE65-5% | <4 days | hazy, glossy and rubbery. |
| Phospholan PE169-0.1% | 1 hour 50 min | smooth, slight haze, glossy. |
| Phospholan PE169-1% | No Cure | clear, very sticky. |
| Phospholan PE169-5% | <20 hours | smooth, very hazy, glossy. |
| Dibutyl Phosphate-0.1% | No Cure | wet, clear, and greasy. |
| Dibutyl Phosphate-1% | <20 hours | smooth, clear, glossy. |
| Dibutyl Phosphate-5% | <4 days | haze, glossy, rubbery. |
| Tributyl Phosphate-0.1% | No Cure | wet and greasy, clear |
| Tributyl Phosphate-1% | No Cure | clear, wet and sticky. |
| Tributyl Phosphate-5% | No Cure | clear, wet and sticky. |
| Tris(trimethylsilyl)phosphate-0.1% | No Cure | clear, wet and greasy. |
| Tris(trimethylsilyl)phosphate-1% | 40 min | smooth, clear, glossy. |
| Tris(trimethylsilyl)phosphate-5% | 23 min | smooth, clear, glossy. |
| Tributylmethylammonium dibutyl | No Cure | clear, wet, sticky. |
| phosphate-0.1% | | |
| Tributylmethylammonium dibutyl | No Cure | clear, wet, sticky. |
| phosphate-1% | | |
| Tributylmethylammonium dibutyl | No Cure | clear, wet, sticky. |
| phosphate-5% | | |
| Nacure XP-333-0.1% | No Cure | clear, wet, sticky. |
| Nacure XP-333-1% | <4 days | smooth, slight haze, glossy. |
| Nacure XP-333-5% | 1 hour 50 min | smooth, slight haze, glossy. |
| Mono-n-dodecylphosphate-0.1% | 3.5 hours | smooth, clear, glossy. |
| Mono-n-dodecylphosphate-1% | 3 hours | smooth, clear, glossy. |
| Mono-n-dodecylphosphate-5% | 20 min | smooth, slight haze, glossy. |
| Bis ethyl hexyl phosphate-1% | 1 hour | smooth, slight haze, glossy. |

Example 1 showed that in this alkoxy curable polydimethylsiloxane composition, with the exception of tributylphosphate and tributylmethylammonium phosphate, all of the catalysts tested could cure the composition at various cure times and catalyst loadings.

To compare reactions at constant catalyst and acid concentration, the acid numbers for the catalysts were calculated. Using this information equivalent amounts of catalyst based on the acid content added to the composition could be calculated allowing better comparison of catalysts. The table below shows the solids content and the acid numbers calculated for all the acid catalysts used in this study to provide some comparison of the different catalysts.

Catalyst composition/solids content and acid numbers.

| Catalyst | Solids (%) | Acid No. |
|---|---|---|
| Nacure 4054 | 50 | 185 |
| Nacure XC-9207 | 48-52 | 258 |
| Nacure XC-C207 | 85-95 | 650 |
| Nacure XC-206 | 50-55 | 179 |
| DOW CORNING ® 4-6085 | 98 | 325 |
| Nacure XP-297 | 25 | 112 |
| Phosphonitrile chloride | 30 | 280 |
| Phospholan PE65 | 100 | 100 |
| Phospholan PE169 | 100 | 115 |
| Dibutyl phosphate | 97 | 371 |
| Tributyl phosphate | 99 | NA |
| Tris (trimethylsilyl) phosphate | 99 | 221 |
| Tributylmethylammonium dibutyl phosphate | | NA |
| Nacure XP-333 | 20 | 272 |
| mono-n-dodecyl phosphate | 90 | NA |
| Bis ethyl hexyl phosphate | 97 | 305 |
| DDBSA | 100 | 263 |
| K-Cure 1040 | 25-50 | 213 |
| K-Cure 129B | 45-55 | 243 |
| Nacure 1059 | 45-55 | 90 |
| Nacure 155 | 50-60 | 168 |
| Nacure XC-178 | 40-50 | 45 |
| Nacure XC-C210 | 100 | 112 |
| Nacure XC-207 | 50 | 47 |

In this alkoxy curable polydimethylsiloxane composition under the cure conditions of Example 1, DOW CORNING® 4-6085 appeared to catalyze slower cure than the phosphate esters, such as Nacure 4054. DOW CORNING® 4-6085 had higher solids content and acid number, so more acid catalyst was present. Without wishing to be bound by theory, it was thought that because more haze was seen at high concentrations with the DOW CORNING® 4-6085, there may have been incompatibility with the base polymer at high catalyst loadings of DOW CORNING® 4-6085 in the composition prepared in this example 2, however, DOW CORNING® 4-6085 was still capable of catalyzing condensation reaction in this composition.

Tristrimethylsilylphosphate catalyzed faster cure than DOW CORNING® 4-6085 under the conditions of Example 1. Without wishing to be bound by theory, it was thought that this was due to tristrimethylsilylphosphate being triacidic rather than diacidic on hydrolysis. Compatibility of tristrimethylsilylphosphate and DOW CORNING® 4-6085 might seem to be better at most catalysts loadings with cured films being clear and glossy, although DOW CORNING® 4-6085 showed slightly hazy films at 5% catalyst loading in the composition of Example 1.

The table below shows the appearance of the uncured compositions prepared in Example 1 after storage in closed containers for 2 days. Most of them were clear when stored in the absence of air/moisture. Exceptions to this were the compositions containing Phospholan catalysts, which gave hazy or very hazy solutions and appeared to show an increase in viscosity. Without wishing to be bound by theory, it was thought that this was due to the high solids content of the catalyst added, both of which were 100% solids with no solvent, as was also the case for Nacure XC-C207, which was also hazy and had high catalyst solids content.

### Example 1

| | Change in | Appearance of solution beyond 2 |
|---|---|---|
| Catalyst-Loading (%) | Viscosity | days |
| None (negative control) | none | Clear, no residues. |
| TNBT-0.1% (control) | none | Clear, no residues. |
| TNBT-1% (control) | none | Clear, no residues. |
| TNBT-5% (control) | none | Clear, no residues. |
| Nacure 4054-0.1% | none | Clear, no residues. |
| Nacure 4054-1% | slight | Clear, no residues. |
| | reduction | |
| Nacure 4054-5% | less viscous | Clear, no residues. |
| Nacure XC-9207-0.1% | none | Clear, no residues. |
| Nacure XC-9207-1% | slight | Clear, no residues. |
| | reduction | |
| Nacure XC-9207-5% | less viscous | Clear, no residues. |
| Nacure XC-C207-0.1% | none | Clear, no residues. |
| Nacure XC-C207-1% | less viscous | Slight haze, no residues. |
| Nacure XC-C207-5% | less viscous | slight haze, no residues. |
| Nacure XC-206-0.1% | none | Clear, no residues. |
| Nacure XC-206-1% | slight | Clear, no residues. |
| | reduction | |
| Nacure XC-206-5% | less viscous | Clear, no residues. |
| DOW CORNING ® 4-6085-0.1% | increase | Clear, no residues. |
| DOW CORNING ® 4-6085-1% | none | Clear, no residues. |
| DOW CORNING ® 4-6085-5% | less viscous | Clear, no residues. |
| Nacure XP-297-0.1% | increase | hazy, no residue |
| Nacure XP-297-1% | increase | very hazy, no residue |
| Nacure XP-297-5% | increase | very cloudy, no residue |
| Phosphonitrile chloride-0.1% | less viscous | Slight haze, no residue |
| Phosphonitrile chloride-1% | less viscous | cloudy, slight white bottom residue |
| Phosphonitrile chloride-5% | less viscous | Very hazy, cloudy bottom residue |
| Phospholan PE65-0.1% | increase | cloudy, no residue. |
| Phospholan PE65-1% | increase | very cloudy, no residues |
| Phospholan PE65-5% | increase | Extremely cloudy, no residue |
| Phospholan PE169-0.1% | increase | Hazy, no residue |
| Phospholan PE169-1% | increase | cloudy, no residue. |
| Phospholan PE169-5% | increase | very cloudy, no residue |
| Dibutyl Phosphate-0.1% | none | Clear, no residues. |
| Dibutyl Phosphate-1% | less viscous | Clear, no residues. |
| Dibutyl Phosphate-5% | less viscous | Clear, no residues. |
| Tributyl Phosphate-0.1% | none | Clear, no residues. |
| Tributyl Phosphate-1% | none | Clear, no residues. |
| Tributyl Phosphate-5% | none | Clear, no residues. |
| Tris(trimethylsilyl)phosphate-0.1% | increase | Clear, no residues. |
| Tris(trimethylsilyl)phosphate-1% | none | Clear, no residues. |
| Tris(trimethylsilyl)phosphate-5% | less viscous | Clear, no residues. |
| Tributylmethylammonium dibutyl | increase | Clear, no residues. |
| phosphate-0.1% | | |
| Tributylmethylammonium dibutyl | increase | cloudy, no residue. |
| phosphate-1% | | |
| Tributylmethylammonium dibutyl | increase | very cloudy, streaky |
| phosphate-5% | | |
| Nacure XP-333-0.1% | none | slight haze, no residue |
| Nacure XP-333-1% | less viscous | Clear, no residues. |
| Nacure XP-333-5% | less viscous | Clear, no residues. |
| Mono-n-dodecylphosphate-0.1% | none | Slight haze, some undizzolved |
| | | residue |
| Mono-n-dodecylphosphate-1% | less viscous | Hazy, some cloudy turbidity |
| Mono-n-dodecylphosphate-5% | less viscous | cloudy, with cloudy white bottom |
| | | residue |
| Bis ethyl hexyl phosphate-1% | less viscous | Clear, no residue. |

This example shows that DOW CORNING 4-6085 is sufficiently compatible with the base polymer and crosslinker of this Example 1 to be formulated into a composition containing a silanol terminated polydiorganosiloxane base polymer and a methoxysilane crosslinker.

### Example 2

### Alkoxy Composition

Samples were prepared according to the method of Reference Example 3 using Ingredient (B1) a silanol terminated polydimethylsiloxane having a viscosity of 4000 cSt as the base polymer and 0.5 g of ingredient (C1) methyltrimethoxysilane as the crosslinker. The catalysts shown below in the table were added as ingredient (A) in amounts of 0.1%, 1.0%, and 5.0%.

### Example 3

| Catalyst-Loading (%) | TFT | Appearance of drawdown film |
|---|---|---|
| TNBT (control)-0.1% | <20 hours | smooth, clear, glossy. |
| TNBT (control)-1% | <20 hours | smooth, clear, glossy. |
| TNBT (control)-5% | <20 hours | smooth, clear, glossy. |
| Nacure 4054-0.1% | No Cure | clear, greasy, wet, sticky. |
| Nacure 4054-1% | 3 hours 30 min | smooth, clear, glossy. |
| Nacure 4054-5% | 1 hour 30 min | smooth, clear, glossy. |
| Nacure XC-9207-0.1% | No Cure | clear, wet, sticky. |
| Nacure XC-9207-1% | 1 hour 20 min | smooth, clear, glossy. |
| Nacure XC-9207-5% | 3 hours 30 min | smooth, hazy, glossy. |
| Nacure XC-C207-0.1% | No Cure | clear, wet, and greasy. |
| Nacure XC-C207-1% | 2 hours 50 min | smooth, slight haze, glossy. |
| Nacure XC-C207-5% | 3 hours 30 min | smooth, clear, glossy. |
| Nacure XC-206-0.1% | No Cure | wet, clear, greasy. |
| Nacure XC-206-1% | 2 hours 50 min | smooth, clear, glossy. |
| Nacure XC-206-5% | 2 hours 40 min | smooth, clear, glossy. |
| DOW CORNING ® 4-6085-0.1% | No Cure | Clear, sticky. |
| DOW CORNING ® 4-6085-1% | 2 hours 40 min | smooth, clear, glossy. |
| DOW CORNING ® 4-6085-5% | 2 hours 40 min | smooth, slight haze, glossy. |
| Nacure XP-297-0.1% | No Cure | clear, wet, greasy. |
| Nacure XP-297-1% | No Cure | clear, tacky. |
| Nacure XP-297-5% | 24 hours | smooth, slightly hazy, glossy. |
| Phosphonitrile chloride-0.1% | No Cure | wet and greasy. |
| Phosphonitrile chloride-1% | 1 hour 15 min | slight grey/brown stain, smooth, |
| | | glossy. |
| Phosphonitrile chloride-5% | 15 min | smooth, hazy, glossy. |
| Phospholan PE65-0.1% | No Cure | clear, wet, and sticky. |
| Phospholan PE65-1% | No Cure | clear and tacky |
| Phospholan PE65-5% | 24 hours | smooth, hazy, glossy. |
| Phospholan PE169-0.1% | No Cure | clear, wet, and greasy. |
| Phospholan PE169-1% | No Cure | clear, and extremely sticky. |
| Phospholan PE169-5% | 24 hours | smooth, hazy, glossy. |
| Dibutyl Phosphate-0.1% | No Cure | clear and sticky. |
| Dibutyl Phosphate-1% | <40 hours | smooth, slight haze, glossy. |
| Dibutyl Phosphate-5% | No Cure | hazy and sticky. |
| Tributyl Phosphate-0.1% | No Cure | Clear, wet, greasy. |
| Tributyl Phosphate-1% | No Cure | Clear, wet, greasy. |
| Tributyl Phosphate-5% | No Cure | Clear, wet, greasy. |
| Tris(trimethylsilyl)phosphate-0.1% | No Cure | Clear, wet, greasy. |
| Tris(trimethylsilyl)phosphate-1% | 16 hours | smooth, clear, glossy. |
| Tris(trimethylsilyl)phosphate-5% | <16 hours | smooth, slight haze, glossy. |
| Tributylmethylammonium dibutyl | No Cure | clear, wet, greasy. |
| phosphate-0.1% | | |
| Tributylmethylammonium dibutyl | No Cure | clear, wet, greasy. |
| phosphate-1% | | |
| Tributylmethylammonium dibutyl | No Cure | clear, wet, greasy. |
| phosphate-5% | | |
| Nacure XP-333-0.1% | No Cure | clear, wet, greasy. |
| Nacure XP-333-1% | <16 hours | smooth, slight haze, glossy. |
| Nacure XP-333-5% | <40 hours | smooth, very hazy, glossy. |
| Mono-n-dodecylphosphate-0.1% | No Cure | Clear, bobbly, very sticky. |
| Mono-n-dodecylphosphate-1% | No Cure | Clear, bobbly, greasy and wet. |
| Mono-n-dodecylphosphate-5% | 20 min | smooth, slight haze, glossy. |

In Example 2, all the compositions showed longer cure times than in Example 1. Higher MTM levels in Example 1 seemed to allow cure with lower catalyst levels. Of the compositions that cured, all of them had better or equivalent cure times than the control containing TNBT at 1% and 5% catalyst loading, but were worse at 0.1% catalyst loading under the conditions of Example 2. Without wishing to be bound by theory, it was thought that poor performance at the low catalyst loading may have been due to loss of the crosslinker through evaporation before it could react with the base polymer and crosslink the composition.

Overall the appearance of the compositions in Example 2 were hazier than the compositions in Example 1 after storage for 2 days, as shown in the table below. More haze was seen at higher catalyst loading. The least hazy compositions in Example 3 contained TNBT (the control), Nacure 4054, Nacure XC-9207, trimethylsilyl phosphate, and DOW CORNING® 4-6085, which showed clear solutions.

### Example 2

| | Change in | Appearance of solution beyond 2 |
|---|---|---|
| Catalyst-Loading (%) | Viscosity | days |
| TNBT(control)-0.1% | slight | Clear, no residues. |
| | increase | |
| TNBT(control)-1% | slight | Clear, no residues. |
| | increase | |
| TNBT(control)-5% | None | Clear, no residues. |
| Nacure 4054-0.1% | Increase | Clear, no residues. |
| Nacure 4054-1% | None | Clear, no residues. |
| Nacure 4054-5% | less | Clear, no residues. |
| | viscous | |
| Nacure XC-9207-0.1% | Increase | Clear, no residues. |
| Nacure XC-9207-1% | less | Clear, no residues. |
| | viscous | |
| Nacure XC-9207-5% | less | Clear, no residues. |
| | viscous | |
| Nacure XC-C207-0.1% | Increase | Clear, no residues. |
| Nacure XC-C207-1% | slight | Clear, no residues. |
| | increase | |
| Nacure XC-C207-5% | less | slight hazy, tiny clear, oily |
| | viscous | droplets throughout |
| Nacure XC-206-0.1% | Increase | slightly hazy, no residue |
| Nacure XC-206-1% | Increase | slightly hazy, no residue |
| Nacure XC-206-5% | Increase | slightly hazy, no residue |
| DOW CORNING ® 4-6085-0.1% | Increase | slight haze, no residue |
| DOW CORNING ® 4-6085-1% | Increase | Clear, no residues. |
| DOW CORNING ® 4-6085-5% | less | Clear, no residues. |
| | viscous | |
| Nacure XP-297-0.1% | Increase | cloudy, no residue. |
| Nacure XP-297-1% | Increase | cloudy, no residue. |
| Nacure XP-297-5% | less | very cloudy, no residue |
| | viscous | |
| Phosphonitrile chloride-0.1% | less | hazy, no residue |
| | viscous | |
| Phosphonitrile chloride-1% | less | cloudy, with cloudy white bottom |
| | viscous | residue |
| Phosphonitrile chloride-5% | less | cloudy, with oily cloudy droplets |
| | viscous | at bottom |
| Phospholan PE65-0.1% | Increase | cloudy, no residue. |
| Phospholan PE65-1% | Increase | Very cloudy, no residues. |
| Phospholan PE65-5% | Increase | extremely cloudy/white, no |
| | | residue |
| Phospholan PE169-0.1% | Increase | very hazy, no residue |
| Phospholan PE169-1% | Increase | very cloudy, no residue. |
| Phospholan PE169-5% | high | very cloudy, no residue. |
| | increase | |
| Dibutyl Phosphate-0.1% | slight | Clear, no residues. |
| | increase | |
| Dibutyl Phosphate-1% | less | Clear, no residues. |
| | viscous | |
| Dibutyl Phosphate-5% | less | clear, slight hazy bottom residue. |
| | viscous | |
| Tributyl Phosphate-0.1% | None | Clear, no residues. |
| Tributyl Phosphate-1% | None | Clear, no residues. |
| Tributyl Phosphate-5% | None | slight haze, no residue |
| Tris(trimethylsilyl)phosphate-0.1% | very high | Clear, no residues. |
| | increase | |
| Tris(trimethylsilyl)phosphate-1% | Increase | hazy, no residue. |
| Tris(trimethylsilyl)phosphate-5% | less | Clear, no residues. |
| | viscous | |
| Tributylmethylammonium dibutyl | slight | Clear, no residues. |
| phosphate-0.1% | increase | |
| Tributylmethylammonium dibutyl | Increase | very hazy, no residue |
| phosphate-1% | | |
| Tributylmethylammonium dibutyl | Increase | very cloudy, clear oily droplets at |
| phosphate-5 % | | surface |
| Nacure XP-333-0.1% | None | hazy, no residues. |
| Nacure XP-333-1% | less | very cloudy, no residues. |
| | viscous | |
| Nacure XP-333-5% | less | very cloudy, no residues. |
| | viscous | |
| Mono-n-dodecylphosphate-0.1% | slight | cloudy turbidity, with bottom |
| | increase | residue. |
| Mono-n-dodecylphosphate-1% | slight | Haze, cloudy turbidity bottom |
| | increase | residue |
| Mono-n-dodecylphosphate-5% | slight | smooth, slight haze, glossy. |
| | increase | |

### Example 3

### Acetoxy Composition

Samples were prepared according to the method of Reference Example 3 using ingredient (B1) a silanol terminated polydimethylsiloxane having a viscosity of 4000 cSt as the base polymer and 1.8 g of ingredient (C2) methyltriacetoxysilane as the crosslinker. With the exception of the negative control, which contained only ingredients (B1) and (C2), each composition tested contained 1% of the catalyst shown in the table below.

### Example 3

| Catalyst | TFT | Appearance of the film |
|---|---|---|
| Negative Control | 20 hours | Smooth, clear, glossy. |
| TNBT (control) | 7 min | Smooth, clear, glossy. |
| DDBSA | <30 seconds | Smooth, clear, glossy. |
| K-Cure 1040 | <3 min | Smooth, clear, glossy. |
| K-Cure 129B | 1 min | Smooth, clear, glossy. |
| Nacure 1059 | 10 seconds | Smooth, clear, glossy. |
| Nacure 155 | 5 min | Smooth, clear, glossy. |
| Nacure XC-178 | 4 min | Smooth, clear, glossy. |
| Nacure XC-C210 | 4 min | Smooth, clear, glossy. |
| Nacure XC-207 | 1 min | Smooth, clear, glossy. |
| Nacure XC 206 | 30 min | Smooth, clear, glossy. |
| DOW CORNING ® 4-6085 | 10 min | Smooth, clear, glossy. |
| Nacure XP-297 | N/A | CURED IN JAR! (very hard and rubbery) |
| Phosphonitrile chloride | INSTANTLY | forms a glossy, rippled surface - dark brown |
| | | staining. |
| Phospholan PE65 | 30 min | Smooth, very slight haze, glossy. |
| Phospholan PE169 | 24 hours | smooth, clear, glossy. |
| Nacure 4054 | 1 hour | smooth, clear, glossy. |
| Nacure XC-9207 | 27 min | smooth, clear, glossy. |
| Dibutyl Phosphate | 40 min | smooth, clear, glossy. |
| Tributyl phosphate | No Cure | clear and very sticky |
| Tris(trimethylsilyl) | >24 hours | smooth, clear, glossy |
| phosphate | | |
| Tributylammonium dibutyl | >24 hours | smooth, clear, glossy. |
| phosphate | | |
| Nacure XP-333 | 7 min | smooth, clear, glossy. |
| Nacure XC-C207 | 5 min | smooth, clear, glossy. |
| Mono-n-dodecyl phosphate | 24 hours | smooth, clear, glossy, with some gelled |
| | | particulates. |
| Bis ethyl hexyl phosphate | 45 min | smooth, slight haze, glossy. |
| Dibutyl Tin Dilaurate | 5 min | smooth, clear, glossy. |
| (control) | | |

The acetoxy curable polydimethylsiloxane composition in this Example 3 cured without catalyst in 20 hours, but addition of catalyst significantly increased the rate of cure with most of the catalysts curing faster than the negative control. Without wishing to be bound by theory, it is thought that the reason Nacure XP-297 cured in the jar was due to this catalyst being dissolved in Water/IPA solvent, which would immediately hydrolyze the methyltriacetoxysilane (MTA) causing cure. Both the phosphorus containing acids and sulfonic acids tested cured the acetoxy composition of Example 3, with most of them producing clear and glossy films in minutes. Without wishing to be bound by theory, it was thought that tributylphosphate and tributylammonium dibutyl phosphate had poor cure because these compounds were not acidic enough to cure the acetoxy composition under the cure conditions of Example 3. Exceptions were Phospholan PE169, tris(trimethylsilyl) phosphate and mono-n-dodecyl phosphate, which were acidic enough but gave no faster cure than the blank without catalyst. The reason for this was unclear.

The appearances of the composition containing MTA after 2 days are shown below in the table. Most of compositions increased in viscosity; only XP-297 gelled completely due to the catalyst being in water/IPA. The composition containing Phosphonitrile chloride had decreased in viscosity. All the samples appeared to be hazy, which may have been due to the solid MTA not being completely miscible in the compositions. Without wishing to be bound by theory, it is thought that this could be greatly reduced by using a mixture of methyltriacetoxysilane and ethyltriacetoxysilane.

### Example 3

| | Change in | |
|---|---|---|
| Catalyst | Viscosity | Appearance of the sample beyond 2 days |
| Negative Control | Increase in | Hazy, with cloudy salty bottom residue. |
| | viscosity | |
| TNBT(control) | Increase in | Milky, no residue. |
| | viscosity | |
| DDBSA | Increase in | Hazy, slight bottom residue |
| | viscosity | |
| K-Cure 1040 | Increase in | Very hazy, no residue. |
| | viscosity | |
| K-Cure 129B | Slight | Very hazy, no residue. |
| | Increase in | |
| | viscosity | |
| Nacure 1059 | Increase in | Slight yellowy haze, crystalline bottom |
| | viscosity | residue. |
| Nacure 155 | Increase in | Very cloudy, no residue. |
| | viscosity | |
| Nacure XC-178 | Increase in | Yellowy brown haziness, with crystalline |
| | viscosity | bottom residue. |
| Nacure XC-C210 | Increase in | Very hazy with long large crystal |
| | viscosity | formations. |
| Nacure XC-207 | Increase in | Yellowy brown haze, with crystalline |
| | viscosity | bottom residue. |
| Nacure XC 206 | Slight | Slight haze, slight crystalline bottom |
| | Increase in | residue |
| | viscosity | |
| DOW CORNING ® 4-6085 | Increase in | Very hazy crystalline bottom residue |
| | viscosity | |
| Nacure XP-297 | Gelled | Cloudy with air bubbles |
| | Completely | |
| Phosphonitrile chloride | Less Viscous | Clear, no residue |
| | (Much less) | |
| Phospholan PE65 | Increase in | Very cloudy no residue. |
| | viscosity | |
| Phospholan PE169 | Increase in | Hazy, no residue |
| | viscosity | |
| Nacure 4054 | Slight | Very slight haze, no residue |
| | Increase in | |
| | viscosity | |
| Nacure XC-9207 | Slight | Hazy, no residue |
| | Increase in | |
| | viscosity | |
| Dibutyl Phosphate | Slight | Slight haze, clear oily congealed bottom |
| | Increase in | residue. |
| | viscosity | |
| Tributyl phosphate | Slight | Slight haze, no residue |
| | Increase in | |
| | viscosity | |
| Tris(trimethylsilyl) | Slight | Hazy no residue |
| phosphate | Increase in | |
| | viscosity | |
| Tributylammonium dibutyl | Slight | Hazy, with clear oily droplets at bottom. |
| phosphate | Increase in | |
| | viscosity | |
| Nacure XP-333 | Increase in | Cloudy, no residue. |
| | viscosity | |
| Nacure XC-C207 | Increase in | Very hazy, no residue |
| | viscosity | |
| Mono-n-dodecyl phosphate | Increase in | Cloudy congealed bottom residue with |
| | viscosity | some congealants from some undissolved |
| | | mono-n-dodecylphosphate. |
| Bis ethyl hexyl phosphate | Increase in | Hazy, no residue. |
| | viscosity | |
| Dibutyl Tin Dilaurate | No change in | Very hazy, no residue |
| (control) | viscosity | |

### Example 4

### Oximo Composition

Samples were prepared according to the method of Reference Example 3 using ingredient (B1) as the base polymer and 1.8 g of ingredient (C3) methyltrioximosilane as the crosslinker. With the exception of the negative control, each sample contained 1% catalyst. Tack Free Time and appearance were evaluated as in Reference Example 3. The results are in the table below.

### Example 4

| Catalyst | Tack Free Time | Appearance of the film |
|---|---|---|
| Negative Control | <4 days | smooth, clear, glossy. |
| TNBT (control) | 20 hours | smooth, clear, glossy. |
| DDBSA | 20 min | smooth, slight haze, glossy. |
| K-Cure 1040 | 1 hour | smooth, slight haze, glossy. |
| K-Cure 129B | 1 hour | smooth, slight haze with dark grey |
| | | streaks, glossy |
| Nacure 1059 | 12 min | smooth, very slight haze, glossy. |
| Nacure 155 | 1 hour 30 min | smooth, very slight haze, glossy. |
| Nacure XC-178 | 25 min | smooth, clear, glossy. |
| Nacure XC-C210 | 10 min | smooth, clear, glossy. |
| Nacure XC-207 | 40 min | smooth, slight haze, glossy. |
| Nacure XC 206 | 1 hour 30 min | smooth, clear, glossy. |
| DOW CORNING ® 4-6085 | 45 min | smooth, streaky, clear, and very glossy. |
| Nacure XP-297 | No Cure | smooth, clear, very sticky. |
| Phosphonitrile chloride | 35 min | smooth, dull grey colour, glossy. |
| Phospholan PE65 | 10 min | smooth, slight haze, glossy. |
| Phospholan PE169 | 2 hours 20 min | smooth, very slight haze, glossy. |
| Nacure 4054 | 1 hour 10 min | smooth, clear, glossy. |
| Nacure XC-9207 | 15 min | smooth, slight haze, glossy. |
| Dibutyl Phosphate | 10 min | smooth, very slight haze, glossy. |
| Tributyl phosphate | <4 days | smooth, clear, glossy. |
| Tris(trimethylsilyl) phosphate | 6 min | rippley streaky congealants, clear. |
| | | (Quasi gelled in pot) |
| Nacure XP-333 | 30 min | smooth, very slight haze, glossy. |
| Nacure XC-C207 | 20 min | smooth, very slight haze, glossy. |
| Mono-n-dodecyl phosphate | 21 hours | smooth, clear, glossy. |
| Bis ethyl hexyl phosphate | 20 min | Smooth, clear, glossy. |
| Dibutyl Tin Dilaurate | 1 hour 20 min | smooth, very slight haze, glossy. |
| (control) | | |

A selection of catalysts were evaluated in the oxime composition of Example 4. The only catalyst evaluated that did not cure this composition was XP-297 the phosphate ester dissolved in water/IPA. Without wishing to be bound by theory, it is thought that this might have been due to the rapid hydrolysis of the oxime crosslinker before it could react with the silanol functional polydimethylsiloxane base polymer. Most of the catalysts cured the compositions in this Example 4 in minutes and gave smooth clear films, even those containing the sulfonic acid catalysts. DOW CORNING® 4-6085 catalyzed faster cure in the composition of this Example 4 than both the DBTDL and TNBT controls.

The appearance of uncured samples prepared in Example 4 after 2 days is given in the table below. Most of the phosphorus containing catalysts showed an increase in viscosity of the uncured composition with XP-297 showing a gel. Without wishing to be bound by theory, it is thought that this gel was probably due to the catalyst containing water. Only the positive controls, TNBT and DBTDL, as well as Nacure 4054 and bis(ethylhexylphosphate) gave clear compositions after 2 days in this oxime composition.

### Example 4

| | | Appearance of the uncured sample |
|---|---|---|
| Catalyst | Change in Viscosity | after 2 days |
| Negative Control | No change in viscosity | Slight taint, but clear, no residue. |
| TNBT (control) | Increase in viscosity | Clear, no residue. |
| DDBSA | Increase in viscosity | Very cloudy, white, no residue |
| K-Cure 1040 | Increase in viscosity | Very cloudy, white, no residue |
| K-Cure 129B | Increase in viscosity | Very cloudy, white, no residue |
| Nacure 1059 | Slight Increase in | Very cloudy, yellowy white, no |
| | viscosity | residue. |
| Nacure 155 | No change in viscosity | Cloudy white, no residue |
| Nacure XC-178 | No change in viscosity | Dirty yellowy cloudiness, no residue. |
| Nacure XC-C210 | No change in viscosity | Very cloudy- dirty yellow, no residue. |
| Nacure XC-207 | No change in viscosity | Very cloudy- dirty yellow, no residue. |
| Nacure XC 206 | Increase in viscosity | Clear with slight taint, no residue. |
| DOW CORNING ® 4- | Increase in viscosity | Cloudy, with milky streaks and |
| 6085 | | globlets. |
| Nacure XP-297 | thick goo | Cloudy white, no residue. |
| Phosphonitrile chloride | No change in viscosity. | Very cloudy and milky |
| Phospholan PE65 | Increase in viscosity | Cloudy milky white, no residue. |
| Phospholan PE169 | Increase in viscosity | Cloudy milky white, no residue. |
| Nacure 4054 | No change in viscosity. | Clear, no residue. |
| Nacure XC-9207 | Increase in viscosity. | Very slight haze, no residue. |
| Dibutyl Phosphate | No change in viscosity. | Clear, with swirly white haze, no |
| | | residue. |
| Tributyl phosphate | No change in viscosity. | Slight haze, no residue. |
| Tris(trimethylsilyl)phosphate | Increase in viscosity | Cloudy white, with cloudy swirly |
| | | streaks and blobs. |
| Nacure XP-333 | Increase in viscosity. | Cloudy white with some cloudy |
| | | streaks |
| Nacure XC-C207 | Increase in viscosity. | Cloudy milky, no residue |
| Mono-n-dodecyl | Increase in viscosity. | very hazy and milky, oily bloblets at |
| phosphate | | bottom. |
| Bis ethyl hexyl | Increase in viscosity | slight yellowy taint |
| phosphate | | |
| Dibutyl Tin Dilaurate | Increase in viscosity. | clear, no residue. |
| (control) | | |

### Example 5

### Resin with Catalysts

Samples were prepared and evaluated using the method in Reference Example 4. Ingredient (B2), a methylmethoxysiloxane with methylsilsesquioxane resin, which was commercially available from Dow Corning Corporation of Midland, Mich., USA was used as the base polymer. With the exception of the negative control (which contained no catalyst), each sample contained 1% catalyst.

### Example 5

| Catalyst | Tack Free Time | Appearance of the film |
|---|---|---|
| Nacure 4054 | No Cure | clear, sticky. |
| Nacure XC-9207 | No Cure | clear, wet. |
| Nacure XC-C207 | 24 hours* | *Slight cure - still wet on very outer edges |
| | | but cured clear, smooth, and glossy. |
| Nacure XC-206 | 24 hours* | *Slight cure - some surface is cured |
| | | although liquid patches remain. clear, |
| | | several small ripples, glossy. |
| DOW CORNING ® 4-6085 | 24 hours* | *Slight cure - most of surface is cured |
| | | although liquid patches remain. clear, |
| | | glossy. |
| NACURE XP-297 | No Cure | clear, and greasy. |
| Phosphonitrile chloride | 24 hours* | Cured surfe with pools of wetness two |
| | | main cured ripples, smooth, brown |
| | | staining, glossy. |
| Phospholan PE65 | No Cure | Clear, wet and gloopy. |
| Phospholan PE169 | No Cure | Clear, wet and gloopy. |
| Dibutyl Phosphate | No Cure | clear, wet. |
| Tributyl phosphate | No Cure | clear, and greasy. |
| Tris(trimethylsilyl)phosphate | <16 hours | smooth, slight haze, glossy |
| Tributylmethylammonium | Not tested | |
| dibutyl phosphate | | |
| Nacure XP-333 | No Cure | Slight haze, sticky. |
| DDBSA | 5 min | clear, wrinkled, glossy. - PEELS |
| K-Cure 1040 | 5 min | clear, blotchy wrinkles, glossy. |
| K-Cure 129B | 3 min | clear, slight wrinklidge, glossy. |
| Nacure 1059 | 6 min | clear, smooth, glossy. |
| Nacure 155 | 3 min | clear, wrinkled, glossy. |
| Nacure XC-178 | 18 min | smooth, hazy, random blotches, glossy. - |
| | | PEELS |
| Nacure XC-C210 | 5 min | smooth, clear, glossy. - PEELS |
| Nacure XC-207 | 5.5 hours | smooth, very slight haze, glossy. |
| US-CF-2403 NO CAT | No Cure | Hazy, wet and gloopy. |
| Dibutyl tin Dilaurate | <16 hours | smooth, clear, and glossy |
| (control) | | |
| TNBT (control) | 2 hours | smooth, clear, glossy. |
| Bis ethyl hexyl phosphate | 3 hours 30 min | Clear, slight haze, glossy. |

### Example 5

| | Change in | Appearance of solution |
|---|---|---|
| Catalyst | Viscosity | beyond 2 days |
| Nacure 4054 | No change. | clear, no residue. |
| Nacure XC-9207 | No change. | clear, no residue. |
| Nacure XC-C207 | No change. | clear, no residue. |
| Nacure XC-206 | No change. | clear, no residue. |
| DOW CORNING ® 4-6085 | No change. | clear, no residue. |
| NACURE XP-297 | No change. | hazy, no residue. |
| Phosphonitrile chloride | No change. | clear, small yellowy |
| | | oily droplets at bottom. |
| Phospholan PE65 | No change. | clear, hazy glass bottom. |
| Phospholan PE169 | No change. | clear, no residue. |
| Dibutyl Phosphate | No change. | clear, no residue. |
| Tributyl phosphate | No change. | clear, no residue. |
| Tris(trimethylsilyl)phosphate | No change. | clear, no residue. |
| Tributylmethylammonium | | |
| dibutyl phosphate | | |
| Nacure XP-333 | No change. | clear, no residue. |
| DDBSA | No change. | cloudy, no residue |
| K-Cure 1040 | No change. | clear, milky bottom layer |
| K-Cure 129B | No change. | clear, milky bottom layer |
| Nacure 1059 | No change. | clear, bronzy colour, |
| | | no residue |
| Nacure 155 | No change. | cloudy, turbid bottom |
| | | half - condensation |
| | | in jar. |
| Nacure XC-178 | No change. | slight cloudiness, bronzy |
| | | brown colour |
| Nacure XC-C210 | No change. | dirty brown cloudiness, |
| | | brown turbidity |
| Nacure XC-207 | No change. | clear, no residue. |
| Negative Control | No change. | clear, no residue. |
| Dibutyl tin Dilaurate | No change. | clear, no residue. |
| (control) | | |
| TNBT (control) | No change. | clear, no residue. |
| Bis ethyl hexyl phosphate | No change. | Clear, no residue. |

### Example 6

### Resinous Base Polymer with Linear Base Polymer

Samples were prepared and evaluated as in Example 5, above, except that in addition to ingredient (B2), a linear polydimethylsiloxane base polymer was added. The linear base polymer was a hydroxy-terminated polydimethylsiloxane with a viscosity of 12 cP and a silanol content of 2.5%. The resin and linear base polymers were mixed before adding the catalyst. Tack Free Time and appearance were evaluated as described above. The results are in the table below.

### Example 6

| CATALYST | Tack Free Time | Appearance of the drawdown film |
|---|---|---|
| Nacure 4054 | No Cure | clear, very greasy, some curing. |
| Nacure XC-9207 | No Cure | clear, wet and greasy |
| Nacure XC-C207 | <16 hours* | clear, smooth, glossy and greasy/wet |
| | | surfaces |
| Nacure XC-206 | <16 hours* | clear, smooth, cured, batches and |
| | | patches - greasy |
| DOW CORNING ® 4-6085 | 3 days* | smooth, clear, glossy, Very greasy |
| NACURE XP-297 | No Cure | clear very wet |
| Phosphonitrile chloride | <16 hours* | cured areas/blotches, glossy and |
| | | greasy - brown staining. |
| Phospholan PE65 | No Cure | very wet and clear. |
| Phospholan PE169 | No Cure | very wet and clear. |
| Dibutyl Phosphate | No Cure | clear, wet and greasy - several cured |
| | | blotches. |
| Tributyl phosphate | No Cure | clear and wet |
| Tris(trimethylsilyl)phosphate | <16 hours | slight haze, smooth, slight matt - |
| | | greasy. |
| Nacure XP-333 | 3 days* | some curing - blotchy. Glossy but |
| | | Very greasy. |
| Mono-n-dodecyl phosphate | <16 hours | smooth, slight haze, glossy, Very |
| | | greasy. |
| Bis ethyl hexyl phosphate | 4 days* | smooth, clear, glossy - some greasy |
| | | blotches |

Of the catalysts tested in the methoxy functional resin composition of Example 6, Nacure XC-C207, Nacure XC-206, 4-6085, tris(trimethylsilyl)phosphate, Nacure XP-333, mono-n-dodecyl phosphate, and his ethyl hexyl phosphate, and DOW CORNING® 4-6085 all exhibited cure. All of the samples tested using this model composition had no change in viscosity after 2 days. Only Nacure XP-297 showed some haze; all other samples were clear.

### Example 6

| | Change in | Appearance of the uncured |
|---|---|---|
| CATALYST | Viscosity | sample beyond 2 days |
| Nacure 4054 | No change. | clear, no residue |
| Nacure XC-9207 | No change. | clear, no residue |
| Nacure XC-C207 | No change. | clear, no residue |
| Nacure XC-206 | No change. | clear, no residue |
| DOW CORNING ® 4-6085 | No change. | clear, no residue |
| Nacure XP-297 | No change. | hazy, no residue. |
| Phosphonitrile chloride | No change. | clear, no residue |
| Phospholan PE65 | No change. | clear, no residue |
| Phospholan PE169 | No change. | clear, no residue |
| Dibutyl Phosphate | No change. | clear, no residue |
| Tributyl phosphate | No change. | clear, no residue |
| Tris(trimethylsilyl)phosphate | No change. | clear, no residue |
| Nacure XP-333 | No change. | clear, no residue |
| Mono-n-dodecyl phosphate | No change. | clear, no residue |
| Bis ethyl hexyl phosphate | No change. | clear, no residue |

### Example 7

Samples were prepared and evaluated as in Example 6, except that the linear base polymer and catalyst were mixed together before being combined with the resinous base polymer. Tack Free Time and appearance were evaluated as described above. The results are in the table below.

### Example 7

| | Tack Free | Appearance of |
|---|---|---|
| Catalyst | Time | the Drawdown Film |
| Nacure 4054 | No Cure | some cured areas but |
| | | clear and greasy. |
| Nacure XC-9207 | No Cure | some cured areas but |
| | | clear and greasy. |
| Nacure XC-C207 | <2 days | smooth, clear, glossy, greasy. |
| Nacure XC-206 | <24 hours | smooth, clear, greasy - glossy. |
| DOW CORNING ® 4-6085 | <2 days | smooth, blotchy rippled, |
| | | greasy - glossy. |
| Nacure XP-297 | No Cure | clear, wet and greasy |
| Phosphonitrile chloride | <24 hours | smooth, rippliness, brown |
| | | staining. |
| Phospholan PE65 | No Cure | wet and greasy also clear. |
| Phospholan PE169 | No Cure | clear, wet and greasy. |
| Dibutyl Phosphate | <2 days | clear, patchy, |
| Tributyl phosphate | No Cure | clear, wet and greasy |
| Tris(trimethylsilyl)phosphate | <16 hours | smooth, hazy matt finish, |
| | | and Very greasy. |
| Tributylmethylammonium | Not tested | Not tested |
| dibutyl phosphate | | |
| Nacure XP-333 | No Cure | some cured areas but clear, |
| | | wet and greasy. |
| Mono-n-dodecyl phosphate | <16 hours | smooth, matt, Very greasy. |
| Bis ethyl hexyl phosphate | No Cure | clear, wet and greasy. |

In the methoxy resin composition where the catalyst was premixed with linears, samples containing Nacure XC-C207, Nacure XC-206, DOW CORNING® 4-6085, Phosphonitrile chloride, dibutyl phosphate, tris(trimethylsilyl)phosphate, and mono-n-dodecyl phosphate exhibited cure as shown by tack free time. Only Nacure XP-297, Phosphonitrile chloride, and Phospholan PE65 exhibited some haze; all other samples were clear with no residue after storage for more than 2 days.

### Example 7

| | Change in | Appearance of the Uncured |
|---|---|---|
| Catalyst | Viscosity | Sample Beyond 2 Days |
| Nacure 4054 | No change. | clear, no residue |
| Nacure XC-9207 | No change. | clear, no residue |
| Nacure XC-C207 | No change. | clear, no residue |
| Nacure XC-206 | No change. | clear, no residue |
| DOW CORNING ® 4-6085 | No change. | clear, no residue |
| Nacure XP-297 | No change. | cloudy, hazy white bottom |
| | | residue. |
| Phosphonitrile chloride | No change. | clear, small oily droplets at |
| | | bottom |
| Phospholan PE65 | No change. | slight haze, no residue |
| Phospholan PE169 | No change. | clear, no residue. |
| Dibutyl Phosphate | No change. | clear, no residue. |
| Tributyl phosphate | No change. | clear, no residue. |
| Tris(trimethylsilyl)phosphate | No change. | clear, no residue. |
| Tributylmethylammonium | No change. | clear, no residue. |
| dibutyl phosphate | | |
| Nacure XP-333 | No change. | clear, no residue. |
| Mono-n-dodecyl phosphate | No change. | clear, no residue. |
| Bis ethyl hexyl phosphate | No change. | clear, no residue. |

### Example 8

Samples were prepared as in Example 6, except that the linear base polymer from Example 6 was replaced with a different linear base polymer, namely hydroxy-terminated polydimethylsiloxane with a viscosity ranging from 38 to 45 cP and a silanol content ranging from 3.6% to 4%. The resin and linear base polymer were premixed before addition of the catalyst. Tack Free Time and appearance were evaluated as described above. Change in viscosity and appearance of the uncured composition beyond 2 days were also evaluated as described above. The results are in the tables below.

### Example 8

| | Tack Free | Appearance of |
|---|---|---|
| Catalyst | Time | the Drawdown Film |
| Nacure 4054 | 3 days | Clear, smooth, rubbery, |
| | | glossy. |
| Nacure XC-9207 | No Cure | Clear, wet and sticky. |
| Nacure XC-C207 | 6 hours | Slight haze, smooth, and |
| | | glossy |
| Nacure XC-206 | 24 hours | smooth, slight haze, glossy. |
| DOW CORNING ® 4-6085 | No Cure | Slight haze, glossy. |
| Nacure XP-297 | No Cure | Clear, greasy. |
| Phosphonitrile chloride | 24 hours | Smooth, clear, glossy - |
| | | brown staining |
| Phospholan PE65 | No Cure | Clear, slight haze wet. |
| Phospholan PE169 | No Cure | Clear, slight haze - greasy. |
| Dibutyl Phosphate | No Cure | Clear sticky and rubbery. |
| Tributyl phosphate | No Cure | Clear, greasy wet. |
| Tris(trimethylsilyl)phosphate | 2 hours | Hazy, smooth, rubbery + |
| | 20 min | delicate to touch, slight gloss |
| DBTDL (control) | <16 hours | smooth, clear, and glossy |
| Nacure XP-333 | No Cure | Smooth, hazy, glossy. |
| Mono-n-dodecyl phosphate | 2 hours | Smooth, clear, glossy. |
| Bis ethyl hexyl phosphate | No Cure | Clear, sticky. |

### Example 8

| | | Appearance of the |
|---|---|---|
| | Change in | Uncured Sample |
| Catalyst | Viscosity | Beyond 2 Days |
| Nacure 4054 | No Change. | Clear, no residue. |
| Nacure XC-9207 | No Change. | Clear, no residue. |
| Nacure XC-C207 | No Change. | Clear, no residue. |
| Nacure XC-206 | No Change. | Clear, no residue. |
| DOW CORNING ® 4-6085 | No Change. | Clear, no residue. |
| Nacure XP-297 | No Change. | Very hazy, no residue. |
| Phosphonitrile chloride | No Change. | Hazy, no residue. |
| Phospholan PE65 | No Change. | Clear, no residue. |
| Phospholan PE169 | No Change. | Clear, no residue. |
| Dibutyl Phosphate | No Change. | Clear, no residue. |
| Tributyl phosphate | No Change. | Clear, no residue. |
| Tris(trimethylsilyl)phosphate | No Change. | Clear, no residue. |
| DBTDL (control) | Cured in Jar - | Clear, no residue. |
| | Soft | |
| Nacure XP-333 | No Change. | Clear, no residue. |
| Mono-n-dodecyl phosphate | No Change. | Clear, no residue. |
| Bis ethyl hexyl phosphate | No Change. | Clear, no residue. |

Most of the samples exhibited good stability and compatibility in the methoxy resin composition of this Example 8 as shown by appearance being clear with no residue with no change in viscosity after storage. Nacure XC-C207 and tris(trimethylsilyl)phosphate catalyzed faster cure of the composition than the DBTDL control in this Example 8.

### Example 9

Samples were prepared as in Example 7, except that the linear base polymer used in Example 7 was replaced with the linear base polymer used in Example 8. The linear base polymer and catalyst were premixed together before being combined with the resinous base polymer. Tack Free Time and appearance were evaluated as described above. Change in viscosity and appearance of the uncured composition beyond 2 days were also evaluated as described above. The results are in the tables below.

### Example 9

| | Tack Free | Appearance of |
|---|---|---|
| CATALYST | Time | the Drawdown Film |
| Nacure 4054 | 3 days | Smooth, clear, glossy. |
| Nacure XC-9207 | No Cure | Clear and sticky |
| Nacure XC-C207 | 6 hours | Smooth, slight haze, glossy. |
| Nacure XC-206 | <3 days | Smooth, hazy, glossy - |
| | | delicate and rubbery. |
| DOW CORNING ® 4-6085 | <2 days | smooth, hazy, glossy. |
| Nacure XP-297 | No Cure | Clear and sticky |
| Phosphonitrile chloride | No Cure | Brown and greasy. |
| Phospholan PE65 | No Cure | Clear and wet. |
| Phospholan PE169 | No Cure | Clear and wet. |
| Dibutyl Phosphate | No Cure | Clear rubbery and tacky |
| Tributyl phosphate | No Cure | Clear and wet. |
| Tris(trimethylsilyl)phosphate | 3 hours | Smooth, hazy, matt finish. |
| DBTDL (control) | <16 hours | Smooth, clear, glossy. |
| Nacure XP-333 | No Cure | Clear blotchy and greasy |
| Bis ethyl hexyl phosphate | 4 days | Clear smooth, glossy. |

### Example 9

| | | Appearance of the |
|---|---|---|
| | Change in | Uncured Sample |
| CATALYST | Viscosity | Beyond 2 days |
| Nacure 4054 | No Change. | Clear, no residue. |
| Nacure XC-9207 | No Change. | Clear, no residue. |
| Nacure XC-C207 | No Change. | Clear, no residue. |
| Nacure XC-206 | No Change. | Clear, no residue. |
| DOW CORNING ® 4-6085 | No Change. | Clear, no residue. |
| Nacure XP-297 | No Change. | Clear, slight hazy bottom |
| | | residue. |
| Phosphonitrile chloride | No Change. | Clear, hazy oily droplets |
| | | bottom residue. |
| Phospholan PE65 | No Change. | Clear, no residue. |
| Phospholan PE169 | No Change. | Clear, no residue. |
| Dibutyl Phosphate | No Change. | Clear, no residue. |
| Tributyl phosphate | No Change. | Clear, no residue. |
| Tris(trimethylsilyl)phosphate | No Change. | Clear, no residue. |
| DBTDL (control) | CURED | Clear, cured jelly |
| Nacure XP-333 | No Change. | Clear, no residue. |
| Bis ethyl hexyl phosphate | No Change. | Clear, no residue. |

Most of the samples exhibited good stability and compatibility in the methoxy resin composition of this Example 9 as shown by appearance being clear with no residue with no change in viscosity after storage. composition

### Example 10

Samples were prepared as in Example 6, except that the linear base polymer used in Example 6 was replaced with a linear base polymer mixture including 75% of a hydroxy terminated polydimethylsiloxane and 25% of a methoxy terminated polydimethylsiloxane, the mixture having a viscosity of 21 cP. The resin and linear base polymers were premixed before addition of the catalyst. Tack Free Time and appearance of the cured sample were evaluated as described above. Change in viscosity and appearance of the uncured composition beyond 2 days were also evaluated as described above. The results are in the tables below.

### Example 10

| | Tack Free | Appearance of |
|---|---|---|
| CATALYST | Time | the Drawdown Film |
| Nacure 4054 | No Cure | Clear, smooth, tacky. |
| Nacure XC-9207 | No Cure | Clear, smooth, tacky. |
| Nacure XC-C207 | 2 days | smooth, clear, glossy. |
| Nacure XC-206 | No Cure | clear, smooth, tacky. |
| DOW CORNING ® 4-6085 | <3 days | smooth, slight haze, glossy. |
| Nacure XP-297 | No Cure | clear, wet, and greasy. |
| Phosphonitrile chloride | No Cure | Smooth, brown, rubbery |
| Phospholan PE65 | No Cure | Clear, glossy. |
| Phospholan PE169 | No Cure | Clear, slight dirty |
| | | staining - sticky |
| Dibutyl Phosphate | No Cure | Clear, slight dirty haze - |
| | | sticky. |
| Tributyl phosphate | No Cure | Clear and wet. |
| Tris(trimethylsilyl)phosphate | 2 days | Clear, smooth, glossy. |
| DBTDL (control) | <16 hours | Clear smooth, rubbery. |
| Nacure XP-333 | No Cure | Clear, slight dirtiness - |
| | | tacky rubbery. |
| Mono-n-dodecyl phosphate | 25 hours | Clear, smooth, glossy. |
| | 30 min | |
| Bis ethyl hexyl phosphate | No Cure | Clear, wet sticky. |

### Example 10

| | | Appearance of the |
|---|---|---|
| | Change in | Uncured Sample |
| CATALYST | Viscosity | Beyond 2 Days |
| Nacure 4054 | No Change. | Clear, no residue. |
| Nacure XC-9207 | No Change. | Clear, no residue. |
| Nacure XC-C207 | No Change. | Clear, no residue. |
| Nacure XC-206 | No Change. | Clear, no residue. |
| DOW CORNING ® 4-6085 | No Change. | Clear, no residue. |
| Nacure XP-297 | No Change. | Clear, slight hazy |
| | | bottom residue. |
| Phosphonitrile chloride | No Change. | Clear, yellow oily |
| | | bottom droplets. |
| Phospholan PE65 | No Change. | Clear, no residue. |
| Phospholan PE169 | No Change. | Clear, no residue. |
| Dibutyl Phosphate | No Change. | Clear, no residue. |
| Tributyl phosphate | No Change. | Clear, no residue. |
| Tris(trimethylsilyl)phosphate | No Change. | Clear, no residue. |
| DBTDL (control) | No Change. | Clear, no residue. |
| Nacure XP-333 | No Change. | Clear, no residue. |
| Mono-n-dodecyl phosphate | No Change. | Clear, no residue. |
| Bis ethyl hexyl phosphate | No Change. | Clear, no residue. |

### Example 11

Samples were prepared as in Example 7, except that the linear base polymer was replaced mixture of linear base polymers used in Example 10. The catalyst and mixture of linear base polymers were premixed before combining them with the resinous base polymer. Tack Free Time and appearance were evaluated as described above for the cured film. Change in viscosity and appearance of the uncured composition beyond 2 days were also evaluated as described above. The results are in the tables below.

### Example 11 Tables

| | Tack Free | Appearance of |
|---|---|---|
| CATALYST | Time | the Drawdown Film |
| Nacure 4054 | No Cure | Clear, smooth, tacky. |
| Nacure XC-9207 | No Cure | Clear, slightly hazy, glossy. |
| Nacure XC-C207 | <16 hours | Clear, slight haze, glossy. |
| Nacure XC-206 | No Cure | Clear, smooth, slight haze, |
| | | glossy. |
| DOW CORNING ® 4-6085 | No Cure | Clear, speckled, slight |
| | | tackiness. |
| Nacure XP-297 | No Cure | Clear and wet. |
| Phosphonitrile chloride | No Cure | Brown staining, tacky and |
| | | rubbery. |
| Phospholan PE65 | No Cure | Clear, dirty haze. Tacky |
| Phospholan PE169 | No Cure | Clear, tainty dirty haze, tacky. |
| Dibutyl Phosphate | No Cure | Clear, slight dirty haze, tacky. |
| Tributyl phosphate | No Cure | Clear wet. |
| Tris(trimethylsilyl)phosphate | <2 days | Clear smooth, glossy. |
| DBTDL (control) | 24 hours | Clear, smooth, glossy. |
| Nacure XP-333 | No Cure | Clear, slight dirty haze, tacky. |
| Mono-n-dodecyl phosphate | 24 hours | Clear, smooth, glossy. |
| Bis ethyl hexyl phosphate | No Cure | Clear, wet. |

### Example 11

| | | Appearance of the |
|---|---|---|
| | Change in | Uncured Sample after |
| CATALYST | Viscosity | Storage Beyond 2 Days |
| Nacure 4054 | No Change. | Clear, no residue. |
| Nacure XC-9207 | No Change. | Clear, no residue. |
| Nacure XC-C207 | No Change. | Clear, no residue. |
| Nacure XC-206 | No Change. | Clear, no residue. |
| DOW CORNING ® 4-6085 | No Change. | Clear, no residue. |
| Nacure XP-297 | No Change. | Clear, slight hazy residue. |
| Phosphonitrile chloride | No Change. | Clear, no residue. |
| Phospholan PE65 | No Change. | Clear, no residue. |
| Phospholan PE169 | No Change. | Clear, no residue. |
| Dibutyl Phosphate | No Change. | Clear, no residue. |
| Tributyl phosphate | No Change. | Clear, no residue. |
| Tris(trimethylsilyl)phosphate | No Change. | Clear, no residue. |
| DBTDL (control) | No Change. | Clear, no residue. |
| Nacure XP-333 | No Change. | Clear, no residue. |
| Mono-n-dodecyl phosphate | No Change. | Clear, no residue. |
| Bis ethyl hexyl phosphate | No Change. | Clear, no residue. |

### INDUSTRIAL APPLICABILITY

The examples show that the phosphonate catalysts tested are capable of catalyzing condensation reaction in various condensation reaction curable compositions. The phosphonate catalysts exhibited superior performance as compared to the controls such as organotin compounds, organotitanium compounds, and catalysts tested in some composition examples. Using the description and examples provided herein, one skilled in the art would be able to formulate various compositions using the phosphonate condensation reaction catalysts and other ingredients described above.

The composition described herein may be free of tin catalysts, such as those described in the Background section, above. Without wishing to be bound by theory, it is thought that the phosphonate catalysts may provide comparable or better cure performance in some condensation reaction curable compositions as shown by certain phosphonates providing faster cure speed at the same or lower catalyst loading, or similar cure speed at lower catalyst loading, as compared to the same composition containing a tin catalyst, as shown in the examples above.

Without wishing to be bound by theory, it is thought that cure speed (as measured by Tack Free Time according to the method of Reference Example 2) may be impacted by the compatibility of ingredient (A) with the other ingredient(s) in the composition, i.e., the cure speed may increase as homogeneity of ingredient (A) in the composition increases. One skilled in the art would recognize that various factors including solubility parameter of ingredient (A), acid number of ingredient (A), the type and the amount of ingredient (B) present, and the selection of any additional ingredients, such as addition of a solvent, may all affect the homogeneity of ingredient (A) in the composition. Therefore, it is possible for a certain (phosphate/phosphonate/sulfonic acid) selected for ingredient (A) to catalyze condensation reaction of the hydrolyzable substituents on various base polymers depending on the selection of the ingredients in the composition. One skilled in the art would be able to formulate various compositions comprising ingredients (A) and (B) based on the description and examples provided herein.

1. A composition comprises:
(A) a phosphonate condensation reaction catalyst, and
(B) a base polymer having an average, per molecule, of one or more hydrolyzable substituents, where the composition is capable of reacting via condensation reaction.

2. The composition of claim 1:
further comprising a polyorganosiloxane backbone.

3. The composition of claim 1:
further comprising a silicone organic copolymer backbone.

4. The composition of claim 1, where ingredient (A) is selected from the group consisting of a monomeric phosphonate, a polymeric phosphonate, and a combination thereof.

5. The composition of claim 1, where ingredient (A) is selected from the group consisting of an organic phosphonate, a silyl phosphonate, or a combination thereof.

6. The composition of claim 1, where ingredient (A) comprises a combination of an organic phosphonate and a silyl phosphonate.

7. The composition of claim 1, where ingredient (A) has average general formula (I): 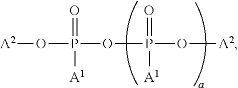
where
each A¹ is independently a monovalent hydrocarbon group;
each A² is independently selected from a hydrogen atom, a monovalent organic group, a silyl group of formula —SiA³₃, where each A³ is independently a monovalent hydrocarbon group, or a siloxane group; and
subscript α has a value of 0 or greater.

8. The composition of claim 7, where each A¹ is independently an alkyl group or an alkenyl group; each A² is independently a hydrogen atom, an alkyl group, an alkenyl group, or a silyl group; each A³ is independently an alkyl group; and subscript a has a value ranging from 0 to 50.

9. The composition of claim 7, where subscript α has a value greater than 0.

10. The composition of claim 7, where each A¹ is independently an alkyl group of 1 to 8 carbon atoms or an alkenyl group of 1 to 8 carbon atoms; and each A² is independently a hydrogen atom, an alkyl group of 1 to 4 carbon atoms, or a silyl group in which each group A¹ bonded to the silicon atom is independently an alkyl group of 1 to 4 carbon atoms.

11. The composition of claim 1, where ingredient (A) comprises diethenyl-diphosphonic acid, vinylphosphonic acid, bis(trimethylsilyl) vinylphosphonate, trimethylsilyl vinylphosphonic acid, bis(dimethylvinylsilyl) vinylphosphonate, dimethylvinylsilyl vinylphosphonic acid, dimethyl methylphosphonate, bis(trimethylsilyl) octylphosphonate, trimethylsilyl octylphosphonate, and octylphosphonic acid, or a combination thereof.

12. (canceled)

13. The composition of claim 1, further comprising at least one ingredient selected from the group consisting of: (C) a crosslinker; (D) a drying agent; (E) an extender, a plasticizer, or a combination thereof; (F) a filler; (G) a treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a solvent; (T) a tackifying agent; and a combination thereof.

14. The composition claim 1, where ingredient (B) comprises: a polymer backbone having covalently bonded thereto an average per molecule of one or more groups of formula (ii): 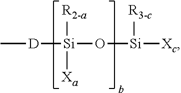
where each D independently represents an oxygen atom or a divalent organic group, each X independently represents a hydrolyzable substituent, each R independently represents a monovalent hydrocarbon group, subscript a represents 0, 1, 2, or 3, subscript b represents 0, 1, or 2, and subscript c has a value of 0 or greater, with the proviso that the sum of (a+c) is at least 1, and at least one X is present in the formula.

15. The composition of claim 1, where ingredient (B) comprises a polydiorganosiloxane of Formula (I): 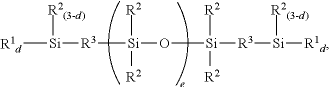
where each R¹ is independently a hydrolyzable substituent, each R² is independently a monovalent organic group, each R³ is independently an oxygen atom or a divalent hydrocarbon group, each subscript d is independently 1, 2, or 3, and subscript e is an integer having a value sufficient to provide the polydiorganosiloxane with a viscosity of at least 100 mPa·s at 25° C.

16. The composition of claim 15, where each R³ is independently a divalent organic group.

17. The composition of claim 14, where the polymer backbone is organic.

18-22. (canceled)
